(19) United States
(12) Patent Application Publication
(10) Pub. No.: US 2026/0300993 A1
(43) Pub. Date: Oct. 1, 2026

(54) COMMUNICATION INTELLIGENCE

(71) Applicant: 8x8, Inc., Campbell, CA (US)

(72) Inventors: Dhwani SONI, Campbell, CA (US); Lisa ORFORD, Campbell, CA (US); Eilon YARDENI, Campbell, CA (US); Bruno BERTINI, Campbell, CA (US); Joel NEEB, Campbell, CA (US); Slobodan MISKOVIC, Campbell, CA (US); Murali PONNURAJ, Campbell, CA (US)

(21) Appl. No.: 19/635,443

(22) Filed: Mar. 31, 2026

Related U.S. Application Data
(60) Provisional application No. 63/781,222, filed on Mar. 31, 2025.

(51) Int. Cl. G06Q 30/015

(52) U.S. Cl. CPC G06Q 30/015

(57) ABSTRACT

One or more methods, device, and/or systems may address issues and/or provide approaches for real-time AI model training based on unique data points accessible only on a communications platform, and approaches for providing insights based on the real-time model training.

### CROSS-REFERENCE TO RELATED APPLICATIONS

This application claims the benefit of U.S. Provisional Application No. 63/781,222, filed Mar. 31, 2025, the contents of which are incorporated herein by reference.

### BACKGROUND

The proliferation of digital communication and remote collaboration tools has significantly increased the volume of data on communications platforms, so much so that finding an answer to a question about a given business, where most internal communication is done online, may require significant computer and human resources.

### SUMMARY

One or more methods, devices, and/or systems may address issues and/or provide approaches for real-time AI model training based on unique data points accessible only on a communications platform, and approaches for providing insights based on the real-time model training.

### BRIEF DESCRIPTION OF THE DRAWINGS

The following detailed description may be better understood in view of the figures, where like reference numerals in the figures indicate like elements, and wherein:

FIG. 1 illustrates an example of a device.

FIG. 2 illustrates an example of a network architecture of a communications network utilized by a platform.

FIG. 3 illustrates an example of a data pipeline in the context of the system architecture according to one or more embodiments described herein.

FIG. 4 illustrates an example of an inference logic and runtime behavior in the context of the system architecture according to one or more embodiments herein.

FIG. 5 illustrates an example method according to one or more embodiments described herein.

### DESCRIPTION

In some organizations, multiple communication channels may be used to engage with customers, partners, and/or internal teams on a (e.g., unified) communications platform. As these channels proliferate, there is an increasing need for a unified communications (UC) platform to accurately interpret user intent and provide meaningful responses through enhanced feature sets. Conventional solutions may rely on basic script-based or FAQ-driven approaches, which may fail to account for the diversity and velocity of data flowing across various channels. This may lead to missed insights and inefficiencies when attempting to respond to user inquiries, especially in cases where user intent may be ambiguous or context-rich information is available but not readily surfaced.

This problem is inefficient for conducting business and inefficient from a computer processing perspective since, in practice, answering a query from an enhanced data set may ultimately improve the accuracy of the response but also reduce future resource demands since further queries may be less likely.

There may be more than one approach to address these and other problems through one or more systems, devices, and/or methods directed to communications intelligence (CI) performed on and/or as part of a UC platform that leverages artificial intelligence and/or machine learning (AI/ML) to provide context-aware and adaptive responses. The CI may ingest data from a plurality of channels, such as voice calls, text messages, emails, chat sessions, social media interactions, etc. (e.g., all gathered from the UC), consolidating these streams into a unified related dataset. The CI may respond based solely on a user query, and/or the CI may respond based on the query supplemented with selectively gathered contextual information drawn from the broader platform data points. In some implementations, the system may infer user intent even when a query appears incomplete or when additional context suggests that the user is actually seeking different information.

As described herein, reference to the communication intelligence and/or the unified communications platform may be interchangeable, and one or both may also be referenced to collectively as the system and/or platform herein.

The disclosed platform may operate in real-time or near real-time, using large-scale, continuously updated datasets to refine its responses and recommendations. Various embodiments may provide immediate suggestions, infer potential follow-up questions, and/or recommend automated actions based on ongoing analysis of user communications and historical patterns. The (e.g., AI/ML) CI engine described herein may be integrated directly into an existing communications platform (e.g., unified communications platform) with a user interface (e.g., an 8×8 Work environment, etc.), so that users may seamlessly engage with an AI-driven bot (e.g., AI bot and/or AI agent of the UC/CI) within a workflow. This integration may include user interface elements that present relevant insights within a communications platform, highlight additional details, and/or enable automated or semi-automated tasks based on the intelligence derived from the underlying communications data.

Certain embodiments may include specialized inference mechanisms to identify whether a user's stated query matches their actual needs or if further clarification is necessary. Other embodiments may provide cross-channel analytics, sentiment analysis, or predictive modeling to recommend next steps. The platform's ability to gather, process, and analyze large volumes of communications data may enable it to deliver insights than conventional legacy query-and-answer systems. By continuously learning from interactions across multiple channels, the system may dynamically adapt its models to improve accuracy, provide deeper context, and deliver actionable intelligence for both routine tasks and more complex interactions.

From a hardware perspective, one notable advantage of such an innovation is the reduction in processing cycles required to handle large-scale communications data. By integrating AI-driven inference directly into the UC, much of the data collection and preliminary analysis may be conducted in-stream and in near real-time-rather than shuttling massive amounts of raw data between multiple remote services. This local or near-edge processing architecture saves on the number of round-trip operations needed and alleviates the load on central servers. In practical terms, it means fewer CPU cycles spent on data formatting or re-transmission, and less bandwidth dedicated to uploading and downloading data. That efficiency may translate into more responsive user experiences, since system resources are freed up for higher-priority tasks and real-time operations.

Another hardware-related advantage comes from the way the system may utilize specialized AI accelerators or GPUs in a more targeted, efficient manner. Because the communications platform may aggregate and preprocess relevant data in a structured format, AI models may run inference tasks without incurring unnecessary overhead from irrelevant or redundant data streams. By trimming the data before passing it to specialized hardware, the platform reduces the memory footprint and processing load. This means that GPUs or dedicated AI chips may achieve higher throughput with lower latency, effectively allowing for more simultaneous user interactions without requiring proportionally higher compute resources or additional hardware nodes.

Additionally, the CI may incorporate caching mechanisms that store commonly needed context locally-either in fast-access memory on the client or in server-side caches that are closely coupled with the AI models. This strategy minimizes repeated lookups over the network, reduces bandwidth usage, and/or allows the system to generate responses with less reliance on external database queries. With data cached closer to the AI inference engine, the overall system may achieve a higher rate of queries per second (QPS) on existing hardware, maximizing resource utilization and efficiency.

Additionally/alternatively, by embedding the solution natively within different host applications and services, the system may offload processing to whichever hardware is most suited for a specific task. For instance, low-latency data transformations might be performed on edge servers physically closer to the end user, while more computationally intensive AI training steps may be scheduled on centralized clusters equipped with large GPU arrays. This kind of adaptive load distribution allows for more effective resource allocation, keeps latency in check, and ensures that hardware resources are used optimally across the entire system.

Non-limiting examples of the present disclosure may be implementable as processing improvements for stand-alone applications or services, which may also be integrated into software computing platforms (“software platforms”). As software data platforms have layers of complexity, technical problems identified herein may be amplified in such implementations which further illustrates the technical advantages presented in the present disclosure. As such, some examples of the present disclosure may be provided in connection with a software platform such as a software communications platform. An exemplary software communications platform provides digital tools and services that enable real-time (or near real-time) information sharing and collaboration amongst users. An example of a software communications platform may be a cloud-based communications platform (cloud-based platform implementation) such as 8×8 Work, among other examples.

The present disclosure is implementable to adapt and improve not only back-end data processing of a software platform but also front-end representations to users provided through a software platform providing further tangible evidence of the technical benefits of the present disclosure. For instance, this may be accomplished through data processing management for computer hardware and software utilized for provision of an exemplary software communications platform via data orchestration (e.g., data flow management for execution of processing components and related applications/services), data integration (e.g., bot connection to applications/services of a software communications platform); and data creation/retrieval (e.g., generation of contextual data insights and suggestions for developers and/or end users). Furthermore, benefits of the present disclosure may yield an improved graphical user interface (GUI) that may be adapted to enable usage of data integrations (e.g., chatbots) and surface contextually relevant data insights, suggestions, etc. for developers and/or end users presentable via applications, services, software platforms, and associated computing devices (e.g., user computing devices).

Non-limiting examples describe systems and methods for data integrations with/within software platforms. For instance, one or more bots may be integrated into a software communications platform to perform specific communications-based tasks associated with features and functionalities provided through a software communications platform. A bot may be a software program configured to interact with systems or users for the performance of specific tasks. In the context of a software communications platform, a bot may be utilized to be directed to communications tasks including management of conversations and associated data/metadata for communication management purposes (e.g., a chatbot). For ease of explanation, a chatbot may be used to describe examples of the present disclosure including within software communications platforms. However, it should be recognized that the present disclosure is able to be configured to work with any type of data integration in any application/service or software platform.

An exemplary software communications platform may include any technology described herein as “cloud-based platform implementation” individually or collectively. In one example, an exemplary software communications platform may comprise but is not limited to a combination of UCaaS, CPaaS, CPaaS features and functionalities, web services, and connected websites, administrative portals/consoles, connected to system infrastructure including phone systems hosted remotely by servers and accessible via the internet. An exemplary software communications platform may uniquely generate and manage contextual data from components and users thereof, which may then be leveraged cross-platform and further with third-party integrations services, platforms, (e.g., including integrations via API) to provide a rich and contextual omni-channel user experience (e.g., across a plurality of communication channels including voice, electronic meetings, chat, email, messaging, digital messaging, social media) that is accessible through an adapted GUI. An adapted GUI of a software communications platform may be configured and presented as a single unified workspace but may also be represented via a plurality of GUI workspaces, collapsible and expandable, including break-out GUI functionality to help manage control over communications across different communication channels (omni-channel). Non-limiting examples of features and functionalities of an exemplary software communications platform comprise: omni-channel communication functionality; bot integrations including conversational chatbots (including AI/ML integrations); workforce management (e.g., supervisory management of users such as agents, enterprise resource planning); data analytics (including user-specific, device-specific, software service-specific such as UCaaS or CCaaS, and/or aggregated); ML/AI integrations for data processing, analysis and augmentation including query/response capabilities, translation, transcription, summarization, sentiment and/or biometric analysis, data insight generation, and generation of recommendations or automation of actions within platform; reporting/report generation; customer relationship management (CRM) tools; device management (e.g., phones including both physical phone devices and softphones, PBX, phone numbers, porting, etc.); issue management including support and help desk ticketing management; transaction processing (including payment transactions); billing management; administrative management control including administrative console apps/services to enablement management of users via user profiles, device profiles; phone systems; works groups, ring groups, call queues, group paging, overhead paging, barge-monitor-whisper); IVR; call routing and distribution; call recording functionality; data storage (e.g., including control over hot and cold storage); phone dialers; conversation management including messaging via chat (individual and group), SMS/MMS, including messaging campaigns, website management, and management of service availability, among other examples.

Non-limiting examples of technical advantages provided based on the one or more techniques described herein, may include, but are not limited to: provision of an improved data orchestration layer for management of data integrations with applications or services and related computer hardware; an adapted software communications platform with improved visibility into processing components further enabling improved issue spotting, remediation, and extend scalability and adaptability of software platforms via data process flow management of data integrations with/within the software platforms and associated system architecture (e.g., bot integrations with a cloud-based communication platform); improved processing efficiency (e.g., reduction in processing cycles, saving resources/bandwidth) for computing devices performing data orchestration, including creating data flows for digital communication across software platform(s), as well as data integration, including integration of bots in applications, services, and software platforms; reduction in latency of computing devices supporting software platforms which may include reduction in latency for back-end computing processing and resulting front-end output during execution of a software platform (e.g., software communications platform); creation, training, and adaptation of artificial intelligence (AI) modeling (e.g., machine learning (ML) integrated within applications/services for processing improvement across a variety of practical applications including data orchestration (e.g., data flow management for execution of processing components and related applications/services), data integration (e.g., bot connection to applications/services of a software communications platform); and data creation/retrieval (e.g., generation of contextual data insights and suggestions for developers and/or end users); an improved graphical user interface (GUI) adapted to surface contextually relevant data insights, suggestions, etc. for developers and/or end users including in applications, services, software platforms; and improved usability (user experience) of host applications/services including customization of data and data augmentation for usage of applications/services, and software platforms (e.g., software communications platforms), among other technical advantages.

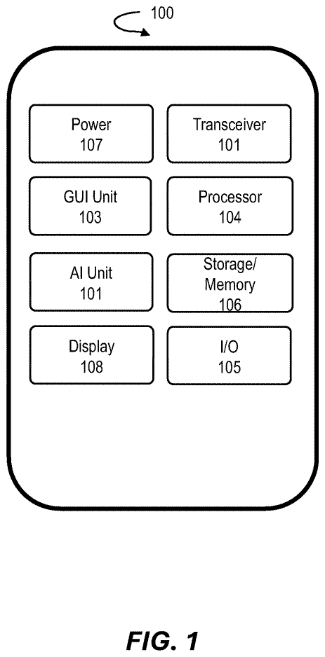

FIG. 1 is an example of a device. The device may take any form, such as a computer, server, a mobile device, networking equipment, communications equipment, phone switch, any device/functionality (e.g., as performed by an entity) described herein, or the like. As used herein, any reference to cloud computing, system computing, or any functionality may be performed on one or more computers. A computer 100 may be described in regard to components, units, and/or functionality that may be performed. A unit or component may represent hardware and/or software that perform a specific function alone or in conjunction with other units. A computer 100 may have one or more components, such as an AI processing unit 1801, a wireless and/or wired transceiver unit 102, a GUI unit 103, a central processing unit 104, an I/O unit 105, a storage/memory unit 106, and/or a power unit 107. A computer 100 may have other hardware or software as is known in the art depending on the type of the device as disclosed herein (e.g., a smartphone may have a camera). For example, the computer may have input/output sensors (e.g., camera, microphone, keyboard, mouse, trackpad, etc.). For example, a computer 100 may run software/application (e.g., modules, etc.) 101 using the processor 104 (e.g., processor) operatively coupled to the storage/memory (e.g., RAM, hard drive, etc.), the transceiver 1102 (e.g., WIFI radio, cellular radio, networking interface, etc.), and a power component 107. In one example, a computer is a user equipment (UE) and sends a message to a communications platform (e.g., with a front end and a back end, where both the front end and back end each have one or more computers associated with it such that their respective functionalities may be performed); the UE may receive a response message from the communications platform, and display a GUI designed to receive commands and/or other user input into the UE. The commands/input may then be sent as a second message to the communications platform. This process may continue as needed (e.g., as described herein, according to one or more techniques, embodiments, examples, etc.).

A meeting may be conducted over a network between at least two devices via the platform using one or more communication channels. The platform may have one or more processing components configured/adapted to manage tasks associated with meeting optimization. For example, there may be a meeting manager component (e.g., associated with one or more servers) that performs one or more functions and is configured to interface with other processing components in an architecture of a software communications platform (e.g., 8×8 Work). In one example, additional sub-components may be configured for specific functionality (e.g., as described herein). Alternatively, individual management components may be configured for different functionalities.

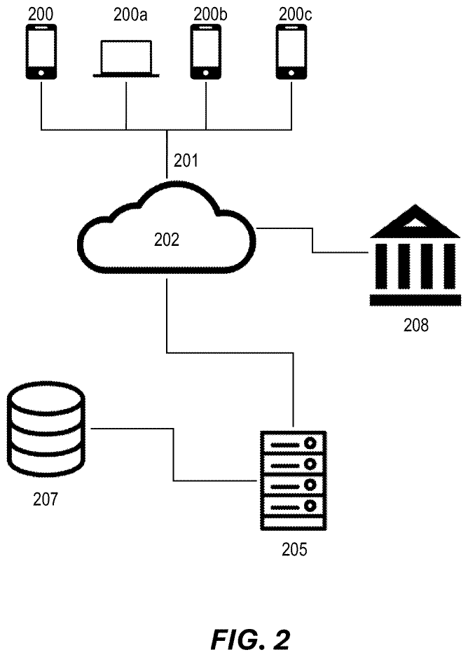

FIG. 2 illustrates an example of a network architecture of a communications network utilized by a platform. The network may have one or more devices for users 200a-c that communicate 201 with a network 202 (e.g., Internet) in a wireless or wired manner. As an example, a user device 200 may be a user equipment (UE), a mobile station, a fixed or mobile subscriber unit, a pager, a cellular telephone, a personal digital assistant (PDA), a smartphone, a laptop, a netbook, a tablet, a personal computer, a wireless sensor, consumer electronics, a television, and the like. A UE 200 may be capable of receiving input and providing output to a user operating the UE 200. The UE 200 may also send and receive information through a local area network or the internet. The UE 200 may connect to the internet, which in turn may access a website/service/platform hosted by a server 205 (e.g., platform) connected by a wired/wireless connection 203. The server 205 and database 207 may represent the infrastructure that facilitates one or more aspects of the platform. In one configuration, the infrastructure may comprise a backend and frontend hosted through a self-hosted or remote-hosted service of several databases and/or servers protected by a firewall and accessed through a load balancer. The platform may have elements that operate on cloud infrastructure such as Amazon® Web Services (AWS), Microsoft® Azure, or the like. The platform may provide Software as a Service (SaaS) or Software as a Product (SaaP). The server 205 may provide service through a website/service/platform/application programming interface (API). The server 205 may be connected 206 to a database 207 that stores information related to input from any of the UEs 200, 200a-c. In an alternative configuration, there may be more than one database 207 and/or the database(s) may be part of server 205. The server 205 may also interact with a payment service 208 (e.g., where a user has paid for access to the platform, etc.).

In one case (not shown in FIG. 2), there may be one or more components within the server (e.g., or its equivalent, like a distributed processing system, or computing instances being run on containers, cloud infrastructure, etc.). For example, there may be an AI management component (e.g., trained and adapted AI/ML Modeling) that provides AI support and functionality. Additionally/alternatively, there may be a third-party vendor integration component, where one or more management components that connect/integrate with the platform to further extend functionality that may be provided by third-party vendors (e.g., CRM integration such as Salesforce, workforce management, PCI payment processing, chatbots, AI integrations (e.g., ChatGPT), etc.). Additionally/alternatively, there may be a GUI/UX component that has widgets, iframes, etc., built in to enable different functionalities and services providable in a comprehensive UI window. Additionally/alternatively, there may be breakout UI windows for different types of functionalities or user-controlled ability to break out windows, manage communications channels, interact with an AI, etc. The GUI may have third-party integrations where UI windows display third-party integrations/functionality.

In some embodiments, the UC platform described herein may further comprise a distributed data processing architecture configured to ingest, normalize, and analyze multi-channel interaction data in real time or near real time. The architecture may include a plurality of coordinated components operating across front-end client devices, edge processing nodes, backend servers, and centralized computing infrastructure, such that heterogeneous communication data is transformed into structured inputs for machine learning processing and downstream workflow execution.

In one embodiment, interaction data originating from a plurality of communication channels—including, but not limited to, voice calls, chat sessions, video conferences, SMS messages, email communications, and third-party system integrations—is received by the platform and routed through an event-driven ingestion layer. The ingestion layer may comprise one or more message queue or event streaming systems configured to receive streaming data events, buffer such events, and distribute the events to downstream processing components in a decoupled manner, thereby supporting high-throughput, low-latency ingestion of both structured and unstructured data streams.

Upon ingestion, the interaction data may be processed by a customer interaction data platform (CIDP) implemented as a data-layer component of the platform and configured to aggregate and normalize the data into a unified data representation. The CIDP may include a unified interaction and profile data layer that associates interaction data with corresponding user profiles, customer records, and historical interaction context. In some implementations, the CIDP performs schema normalization, metadata tagging, and cross-channel correlation to generate a persistent, context-enriched dataset accessible to downstream processing components. For example, transcripts derived from voice or video interactions may be combined with chat logs, CRM records, and prior interaction history to create a consolidated interaction record associated with a particular entity.

The CIDP may further include one or more subcomponents, such as an insight collector, a workspace request handler, and a front-end data feed. The insight collector may be configured to aggregate derived data attributes, including sentiment scores, intent classifications, escalation indicators, and other metadata generated through analysis of the interaction data. The workspace request handler may manage requests for contextual data originating from user interfaces or automated processes, while the front-end data feed may deliver processed insights and contextual information to one or more client interfaces in real time.

In some embodiments, the normalized data produced by the CIDP may be stored in one or more data repositories, including an insights data warehouse configured for long-term storage and analytics, and one or more low-latency data stores or caching layers configured to support real-time access. The caching layer may store frequently accessed contextual data and intermediate processing results in fast-access memory, thereby reducing repeated database queries and improving system responsiveness.

The platform may further comprise a communications intelligence (CI) engine configured to process normalized data from the CIDP using one or more machine learning models. The CI engine may include a plurality of modular components, such as one or more natural language processing (NLP) modules, a context inference engine, and a recommendation engine. The NLP modules may process textual or transcribed input to extract linguistic features, including tokens, entities, and semantic relationships. The context inference engine may combine current interaction data with historical and profile-based data to determine user intent and contextual relevance. The recommendation engine may generate outputs including suggested responses, next-best actions, workflow triggers, or automated operations based on the inferred context.

In some implementations, the CI engine may operate in conjunction with an AI processing unit and one or more hardware acceleration resources, such as graphics processing units (GPUs) or tensor processing units (TPUs), to execute inference operations efficiently. The platform may further include centralized computing clusters configured to perform model training and retraining using aggregated datasets derived from the CIDP. Training processes may utilize distributed computing techniques and may incorporate incremental or streaming-based learning approaches to update models based on newly ingested data.

A model repository may be provided to store trained models, wherein the model repository includes version control mechanisms and automated testing pipelines configured to validate model performance prior to deployment. In some embodiments, models may be deployed using staged rollout techniques, including canary deployments or A/B testing, to maintain system stability while introducing updated models.

The platform may additionally include an integration framework comprising a plurality of connectors configured to interface with external systems, including customer relationship management (CRM) systems, calendar services, task management platforms, and third-party artificial intelligence services. The integration framework may enable the CI engine to retrieve external data during inference and to execute actions in external systems, including updating records, scheduling events, or initiating workflows.

In operation, a user query or system-triggered event may initiate an inference workflow in which contextual data is retrieved from the CIDP and caching layer, processed by the CI engine, and used to generate one or more outputs. These outputs may include structured insights, inferred context, and recommended or automated actions. The outputs may be transmitted to a graphical user interface (GUI) component of the platform, where the outputs are presented within a communication context, including a chat interface, meeting interface, or dashboard.

In some embodiments, portions of the data processing pipeline may be executed on edge computing resources located in proximity to user devices. For example, initial data transformations, including speech-to-text processing or preliminary filtering, may be performed at edge servers to reduce latency and bandwidth consumption. More computationally intensive operations, including model training or large-scale inference, may be executed on centralized computing clusters. This distributed processing architecture improves system performance by reducing data transfer overhead, optimizing resource utilization, and enabling real-time responsiveness.

In certain implementations, the platform may further include indexing and retrieval components configured to enable efficient querying of interaction data and associated metadata. Such components may maintain searchable indices of transcripts, interaction records, and derived insights, thereby facilitating rapid retrieval of contextual data for use in inference workflows.

Additionally, the platform may incorporate monitoring and observability components configured to track system performance metrics, including inference latency, model accuracy, and data throughput. These components may support dynamic adjustment of processing parameters and model configurations to maintain performance over time.

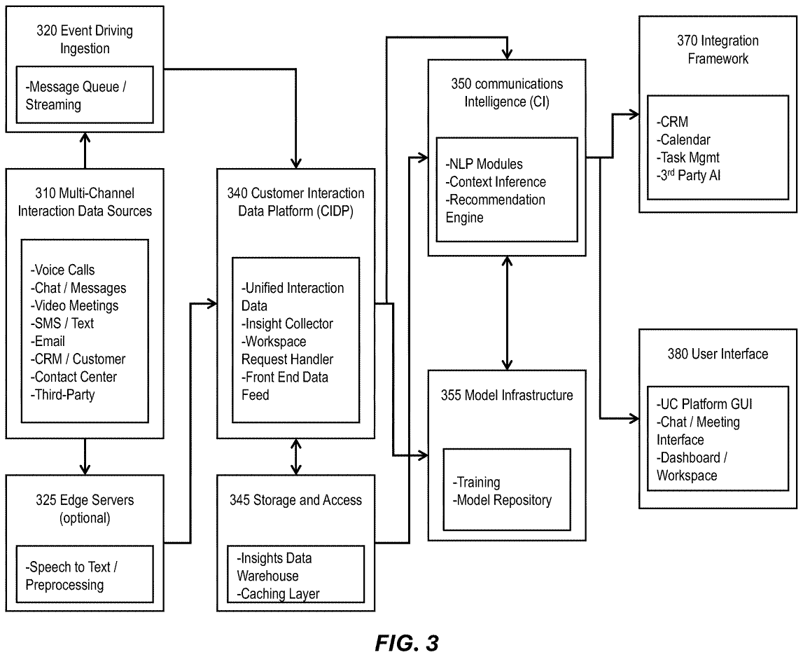

FIG. 3 illustrates an example of a data pipeline in the context of the system architecture according to one or more embodiments described herein.

As shown, there is a system architecture 300 for processing multi-channel interaction data within a unified communications (UC) platform to generate context-aware insights, recommendations, and automated actions. While the platform has one or more components, it may be understood that the platform orchestrates and/or controls the operation of the entire system. In one instance, the one or more components may be considered to be a part of the platform.

As shown in FIG. 3, the system architecture 300 includes a plurality of components configured to operate in a coordinated manner, including multi-channel interaction data sources 310, an event-driven ingestion component 320, optional edge servers 325, a customer interaction data platform (CIDP) 340, storage and access components 345, a communications intelligence (CI) engine 350, model infrastructure 355, an integration framework 370, and a user interface 380.

Multi-channel interaction data sources 310 represent heterogeneous communication inputs generated across a UC platform, including but not limited to voice calls, chat or messaging interactions, video meetings, SMS or text communications, email communications, customer relationship management (CRM) data, contact center data, and third-party system data. These data sources 310 may include both structured and unstructured data streams associated with user interactions and system events.

The interaction data from the multi-channel interaction data sources 310 may be transmitted to an event-driven ingestion component 320. The event-driven ingestion component 320 may include one or more message queue or streaming systems configured to receive, buffer, and distribute data events in a decoupled manner. In this regard, the event-driven ingestion component 320 enables scalable, high-throughput, and low-latency ingestion of interaction data into downstream processing components.

In some embodiments, optional edge servers 325 may be provided to perform preliminary processing operations on the interaction data prior to ingestion. Such operations may include speech-to-text conversion, filtering, or other preprocessing functions. The use of edge servers 325 may reduce latency and bandwidth consumption by performing initial transformations proximate to the data source.

Data ingested via the event-driven ingestion component 320 may be transmitted to the customer interaction data platform (CIDP) 340. The CIDP 340 is implemented as a data-layer component of the platform and is configured to aggregate, normalize, and correlate interaction data from multiple channels. As illustrated, the CIDP 340 may include a unified interaction data layer, an insight collector, a workspace request handler, and a front-end data feed. The CIDP 340 associates interaction data with corresponding user profiles, customer records, and historical interaction context to generate a unified, context-enriched dataset.

The CIDP 340 may be operatively coupled to storage and access components 345, which may include an insights data warehouse and a caching layer. The insights data warehouse may be configured to store aggregated interaction data and derived insights for long-term analysis, while the caching layer may provide low-latency access to frequently accessed data and intermediate processing results. In some implementations, the CIDP 340 and storage and access components 345 may exchange data bidirectionally to support both real-time and historical data retrieval.

Normalized and context-enriched data from the CIDP 340 may be provided to a communications intelligence (CI) engine 350. The CI engine 350 is configured to process the data using one or more machine learning models. As shown, the CI engine 350 may include one or more natural language processing (NLP) modules, a context inference engine, and a recommendation engine. The NLP modules may extract linguistic features from textual or transcribed data, the context inference engine may determine user intent and contextual relevance by combining current and historical data, and the recommendation engine may generate outputs including suggested responses, next-best actions, and automated workflow operations.

The CI engine 350 may further interact with model infrastructure 355, which may include training components and a model repository. The model infrastructure 355 may be configured to support training, retraining, storage, and version control of machine learning models used by the CI engine 350. In some embodiments, the CI engine 350 may retrieve models from the model repository for inference and may provide data to the model infrastructure 355 to support ongoing training processes.

The CI engine 350 may be operatively coupled to an integration framework 370. The integration framework 370 may include one or more connectors configured to interface with external systems, including CRM systems, calendar systems, task management systems, and third-party artificial intelligence services. Through the integration framework 370, the CI engine 350 may retrieve external data and/or initiate actions in external systems based on generated insights or recommendations.

Outputs generated by the CI engine 350 may be transmitted to a user interface 380 associated with the UC platform. The user interface 380 may include one or more graphical user interface (GUI) components, such as a UC platform GUI, chat or meeting interfaces, and dashboards or workspace views. The outputs presented via the user interface 380 may include context-aware insights, recommendations, inferred information, and selectable or automated actions, thereby enabling users to interact with and act upon system-generated intelligence within ongoing communication workflows.

In operation, the system architecture 300 enables a structured transformation of multi-channel interaction data into context-aware outputs by coordinating ingestion, aggregation, normalization, machine learning processing, and integration with external systems. This architecture improves processing efficiency, reduces latency, and enhances the accuracy and relevance of outputs by leveraging unified data representations and distributed processing across edge and centralized resources.

In particular, the architecture illustrated in FIG. 3 provides concrete improvements to computer processing efficiency by reducing unnecessary data movement and redundant computation. For example, preprocessing operations performed at the edge servers 325 reduce the volume of raw data transmitted to backend components, thereby conserving network bandwidth. The event-driven ingestion component 320 and CIDP 340 normalize and filter interaction data prior to machine learning processing, which reduces the amount of irrelevant or duplicative data processed by the CI engine 350 and associated model infrastructure 355, thereby lowering CPU and accelerator utilization. Additionally, the use of the caching layer within storage and access components 345 enables reuse of previously computed contextual data, reducing repeated database queries and associated processing cycles. Collectively, these architectural features decrease end-to-end latency, improve throughput, and enable real-time or near real-time generation of context-aware outputs using fewer computational resources relative to systems that process unstructured communication data in a non-integrated or batch-oriented manner.

In certain embodiments, the communications intelligence (CI) engine described herein may be configured to implement a multi-stage inference pipeline operating on normalized interaction data provided by the customer interaction data platform (CIDP). The multi-stage inference pipeline may comprise a plurality of coordinated inference layers, including an intent disambiguation layer, a contextual enrichment layer, and a predictive follow-up generation layer. These inference layers may be executed sequentially and/or iteratively within a single inference workflow initiated in response to a user query or system-triggered event, as described above with respect to retrieval of contextual data from the CIDP and associated caching layers. Outputs from one inference layer may be propagated to subsequent layers, enabling compound reasoning over both current interaction data and historical, cross-channel context maintained by the CIDP.

In some implementations, the intent disambiguation layer may be implemented as part of, or in conjunction with, the NLP modules and context inference engine of the CI engine. The intent disambiguation layer may process normalized interaction data, including textual input, transcribed speech, and associated metadata, to determine one or more candidate user intents. In addition to analyzing the current interaction, the intent disambiguation layer may retrieve temporally relevant interaction records and profile data from the CIDP, thereby incorporating cross-channel context into the intent determination process. In certain embodiments, the CI engine may generate vector representations (embeddings) of interaction data across different modalities and may utilize such representations to perform similarity analysis across channels. Based on this analysis, the CI engine may identify discrepancies between a literal interpretation of a user query and a likely intended objective, and may assign confidence scores or divergence indicators reflecting such determinations.

In certain embodiments, the contextual enrichment layer may be implemented as a context assembly process executed by the context inference engine in coordination with the CIDP and one or more data repositories. The contextual enrichment layer may dynamically construct a context object corresponding to a given interaction by aggregating data from the CIDP, including user profiles, account-level records, historical interaction data, and derived metadata such as sentiment, topics, and escalation indicators. The contextual enrichment layer may apply relevance scoring, temporal weighting, and cross-channel correlation to prioritize and organize retrieved data. The resulting context object may represent a structured, context-enriched dataset reflecting both historical interactions and real-time system state, and may be generated at inference time in response to a query or event.

In some implementations, the predictive follow-up generation layer may be implemented as part of the recommendation engine of the CI engine. The predictive follow-up generation layer may generate one or more predicted future interactions, recommended actions, and/or workflow triggers based on outputs from the intent disambiguation layer and the contextual enrichment layer. For example, the CI engine may analyze contextual data retrieved from the CIDP to identify unresolved topics, recurring patterns, or prior interaction gaps, and may infer likely subsequent queries or actions. Based on such inferences, the recommendation engine may generate suggested follow-up queries, scheduling recommendations, automated communications, or updates to external systems via the integration framework. In this manner, the CI engine may extend beyond reactive response generation to provide forward-looking, context-aware assistance.

In certain embodiments, the CI engine may utilize one or more machine learning models to perform the inference operations described herein. Such models may include natural language processing models, classification models, and/or generative models. In some implementations, the CI engine may further incorporate advanced model architectures, including large language models (LLMs), retrieval-augmented generation (RAG) frameworks, and/or embedding-based retrieval systems. In such implementations, normalized data from the CIDP and associated data stores may be indexed in one or more retrieval structures, including vector databases and/or graph-based data structures, to support semantic and relational retrieval of contextual data. These advanced components may be implemented as part of, or in conjunction with, the indexing and retrieval components described above.

In some embodiments, the platform may maintain an interaction graph or similar relational data structure representing associations among interaction events, users, accounts, and related entities. Such a structure may be implemented within the indexing and retrieval components and may enable efficient traversal and retrieval of related interaction data from the CIDP and associated repositories. Nodes within the structure may represent interaction events or entities, while edges may represent temporal, causal, or semantic relationships. The structure may be continuously updated based on streaming interaction data received via the event-driven ingestion layer, thereby maintaining an up-to-date representation of ongoing communications.

In certain embodiments, the normalized interaction data generated by the CIDP may conform to a unified data schema that enables consistent processing across communication channels. Interaction data originating from voice, chat, email, social media, and other sources may be transformed into standardized interaction records that include timestamps, channel identifiers, participant identifiers, content representations, and associated metadata. The CIDP may further enrich such records with derived attributes, including sentiment scores, intent classifications, and entity annotations, as described above. This unified representation may enable the CI engine to perform cross-channel analysis and inference using a consistent data structure.

In some implementations, the CI engine may operate in conjunction with the event-driven ingestion pipeline and associated processing components described above. Interaction data received via the ingestion layer may be transformed, enriched, and stored in the CIDP and associated data stores, including an insights data warehouse and one or more low-latency data stores or caching layers. The CI engine may access such data in real time or near real time to support inference workflows. In certain embodiments, streaming data buffers and caching mechanisms may provide access to recently ingested interaction data, enabling the CI engine to incorporate live interaction state into its processing.

In certain embodiments, the CI engine may perform real-time context assembly and injection during inference. Upon receiving a user query or system-triggered event, the CI engine, via the context inference engine, may retrieve relevant contextual data from the CIDP, caching layer, indexing components, and/or streaming data buffers. The retrieved data may be aggregated into a structured context bundle, which may be ranked and filtered based on criteria including semantic relevance, temporal proximity, and contextual importance. The context bundle may then be provided as input to one or more machine learning models of the CI engine, including generative models where implemented, thereby enabling response generation that reflects both the query and the current system state.

In some implementations, caching mechanisms described above may be leveraged to store frequently accessed contextual data and intermediate inference results. Such cached data may be maintained in fast-access memory and selectively updated as new interaction data is processed by the CIDP. This approach may reduce latency associated with repeated data retrieval and may improve responsiveness of the CI engine during inference workflows.

In certain embodiments, an orchestration layer may be implemented within or in association with the CI engine to coordinate execution of inference operations. The orchestration layer may manage sequencing of model execution, data flow between components, and integration with external systems via the integration framework. For example, the orchestration layer may coordinate execution of NLP modules for intent analysis, context retrieval from the CIDP, and recommendation generation, and may further manage invocation of external services or APIs to execute recommended actions.

In some embodiments, the CI engine may dynamically adapt its inference behavior based on system state, user preferences, or operational constraints. For example, the CI engine may adjust the scope of context retrieval or selection of models based on latency requirements, available computing resources, or characteristics of the interaction. The platform may further utilize monitoring and observability components to track performance metrics, including inference latency and model accuracy, and may adjust processing parameters or model configurations accordingly.

Through coordinated operation of the ingestion layer, CIDP, CI engine, data repositories, and integration framework, the platform provides a structured transformation of multi-channel interaction data into context-aware outputs that are integrated directly into communication workflows. This architecture reduces computational overhead, improves latency, and enhances accuracy of system-generated outputs relative to systems that process communication data in isolated or batch-oriented manners.

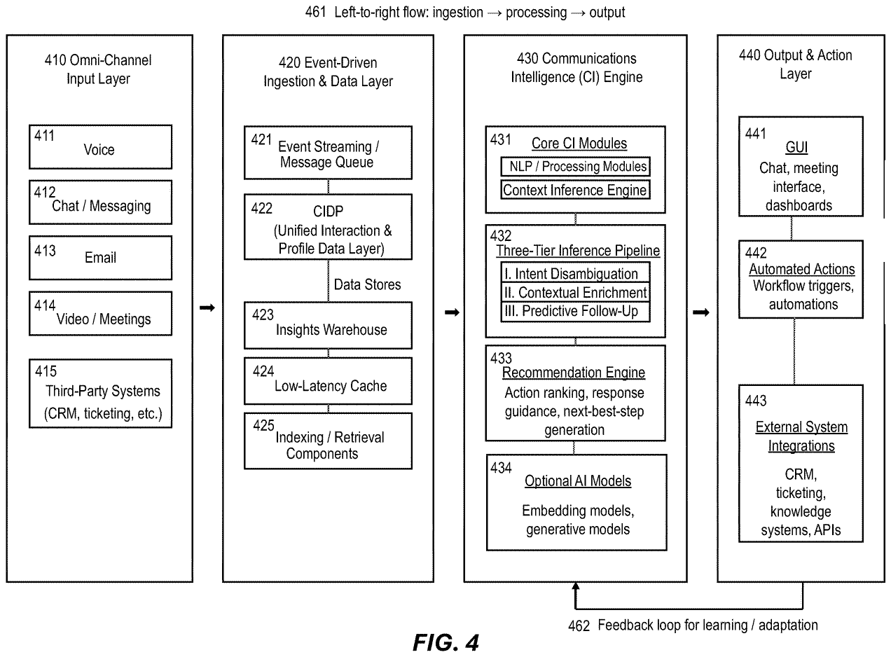

FIG. 4 illustrates an example of an inference logic and runtime behavior in the context of the system architecture according to one or more embodiments herein.

As shown, there is a high-level system architecture 400 of a communications platform configured to provide communications intelligence across a plurality of communication channels, arranged in a left-to-right flow of ingestion→processing→output. The system includes an omni-channel input layer 410, an event-driven ingestion and data layer 420, a communications intelligence (CI) engine 430, and an output and action layer 440, with a feedback loop 462 for learning and adaptation.

The omni-channel input layer 410 comprises a plurality of communication endpoints, including voice (411), chat or messaging (412), email (413), video or meetings (414), and third-party systems (415) such as customer relationship management (CRM) platforms or ticketing systems. Interaction data originating from these channels is transmitted to the event-driven ingestion and data layer 420.

The event-driven ingestion and data layer 420 includes event streaming or message queue components (421) configured to receive and distribute interaction data in a decoupled manner. The ingestion layer provides interaction data to a customer interaction data platform (CIDP) (422), which aggregates, normalizes, and correlates the interaction data into a unified representation. The CIDP 422 is associated with one or more data stores, including an insights warehouse (423) for persistent storage, a low-latency cache (424) for real-time access, and indexing/retrieval components (425) to enable efficient querying of interaction data and associated metadata.

The communications intelligence (CI) engine 430 is communicatively coupled to the CIDP 422 and associated data stores and processes normalized interaction data. The CI engine includes core CI modules (431), such as NLP/processing modules and a context inference engine. It further implements a three-tier inference pipeline (432) comprising: (I) intent disambiguation, (II) contextual enrichment, and (III) predictive follow-up. A recommendation engine (433) generates action rankings, response guidance, and next-best-step outputs. Optional AI models (434), including embedding models and generative models, may be incorporated to enhance processing.

Within the inference pipeline 432, the intent disambiguation stage determines candidate user intents based on current interaction data and contextual signals from the CIDP 422. The contextual enrichment stage constructs a context object using cross-channel interaction data, user profiles, and metadata. The predictive follow-up stage generates recommended actions, predicted future interactions, or workflow triggers based on preceding outputs.

The output and action layer 440 includes GUI components (441) configured to present outputs within communication contexts, including chat interfaces, meeting interfaces, and dashboards. It further includes automated actions components (442) for workflow triggers and automations, as well as external system integrations (443) enabling interaction with CRM systems, ticketing platforms, knowledge systems, and APIs.

A feedback loop 462 feeds outputs, user interactions, and system performance data back to the CI engine 430 and/or data layer 420 to support continuous learning, model refinement, and system adaptation.

In one embodiment, a CI (e.g., where a user-facing element may be presented as an AI bot/agent, etc.) may be part of the platform and may be realized as a multi-tier system that includes a front-end client application, a backend server, and a machine learning (ML) engine interconnected via a network. The platform may include a centralized server or cluster of servers that orchestrate the CI functions, such as speech recognition, natural language processing (“NLP”), and data retrieval from external databases. The front-end interface (e.g., a desktop application, mobile app, or web-based portal) enables meeting participants to interact with the AI bot during scheduling, agenda creation, and the meeting itself.

On initialization, the CI loads or retrieves user-profiles and meeting context data, which may be stored in a database or distributed across multiple data stores. The CI's core intelligence resides in one or more NLP modules that process real-time audio or textual inputs during meetings. These modules tokenize and parse participant statements, identify relevant keywords (e.g., “financial update,” “sales pipeline,” “technical blocker”), and map them to recognized subject matter categories. The CI may also employ a context inference engine that applies machine learning models (e.g., topic modeling, transformer-based language models) to glean the user's intent and identify high-priority agenda items or outstanding action items.

The backend further comprises a recommendation engine configured to propose next steps or schedule follow-up communications. Based on signals from the NLP modules and context inference engine, the recommendation engine may evaluate factors such as deadlines, user availability, and topic urgency. If the AI bot detects an unresolved topic requiring additional expertise, it may query a role-based directory or user profile data store to determine the most relevant stakeholders. The recommendation engine may then notify them and proceed to schedule a meeting and/or add the new participant to an existing communication channel. In certain implementations, the system may automatically generate meeting invites, send messages within a given communications channel, send relevant files, update project management software, etc.

To enhance the UC integrated with CI, there may be dedicated integration modules that enable seamless data exchange with a variety of third-party systems, including but not limited to Customer Relationship Management (CRM) platforms (e.g., Salesforce), productivity suites (e.g., Google Workspace, Microsoft 365), and other enterprise software tools. Each integration module manages secure communication with a target third-party system via application programming interfaces (APIs), webhooks, or direct database connections. For instance, when the AI bot detects a request for a “sales performance update” during a meeting, the integration module corresponding to the CRM platform may authenticate the system's credentials, query up-to-date sales pipeline information, and deliver the relevant metrics to the meeting participants in real-time.

In one exemplary use case, upon receiving a user command such as “Provide the latest leads from Salesforce,” an AI bot's NLP module interprets this request and triggers the Salesforce integration module. This module establishes a secure API session using OAuth or another authentication protocol, retrieves the requested lead data, and reformats it as needed (e.g., generating a concise table or visual chart). The reformatted information is then displayed within the platform interface or shared as a link in the chat, allowing participants to collaboratively review and discuss the data without leaving the meeting environment.

Similarly, for calendar synchronization, the AI bot may integrate with Google Calendar or Microsoft Outlook via respective APIs to check user availability, propose meeting times, and automatically send out event invitations. The system may further leverage these integrations to attach pertinent documents—retrieved from Google Drive, Microsoft SharePoint, or other cloud storage solutions—to meeting events. The AI bot may also interface with task management platforms or product lifecycle management (PLM) tools so that any newly assigned action items are automatically logged with appropriate deadlines and assigned owners.

Moreover, the UC integrated with CI may be extensible, allowing administrators or developers to add additional integration modules for proprietary or custom enterprise systems. In such implementations, a standardized integration framework exposes hooks (e.g., RESTful endpoints or message bus channels) that may ingest and emit data according to the third-party system's schema. This modular design ensures that the UC remains adaptable and easily scalable as new integration requests or enterprise requirements arise.

To maintain data security and compliance, the platform may employ encryption protocols (e.g., TLS/SSL for in-transit data and AES for at-rest data) alongside fine-grained access controls. User permissions are typically managed through an identity and access management (IAM) layer, ensuring that only authorized entities and processes may retrieve or modify sensitive information from integrated systems. Any personal or confidential data handled by the AI bot is anonymized or masked where appropriate, while raw access logs may be retained for troubleshooting or audit purposes.

Generally, Communications Intelligence is AI-powered tools and/or analytics that may be offered within a unified communication platform, such as a cloud-based software communications platform. The AI intelligence may help organizations improve their customer engagement, support, and business operations by utilizing AI to analyze and interpret communication data across multiple channels. A unified communications platform may integrate integrating voice, video, chat, and/or contact center solutions, providing a unified approach to external (e.g., customers) and/or internal interactions.

There may be one or more features of communications intelligence, as described herein, such as, but not limited to, AI-powered analytics, speech and text analytics, omni-channel insights, and/or personalized recommendations.

For AI-powered analytics, the CI may use artificial intelligence to automatically analyze conversations and interactions across various communication channels (such as voice, chat, email, and video). This may enable the platform to gain insights into customer sentiment, intent, and/or overall experience.

For speech and text analytics, by using AI and machine learning algorithms, the CI may process and analyze the content of both voice and text interactions in real-time. This may enable the platform to identify trends, common customer issues, and/or areas for improvement.

For omni-channel insights, the CI may gather data from various communication channels within a given platform, whether it's a phone call, a web chat, or a social media message, and provide a holistic view of customer interactions. This enables the platform to have a repository of robust analysis of customer needs and preferences across different touchpoints.

For personalized recommendations, the CI may offer suggestions for improving customer interactions to a given user, such as identifying cross-sell or up-sell opportunities, recommending the best responses for customer queries, and/or flagging potential issues before they escalate.

The system may generate Omni-Channel Insights leveraging trained AI. The system may use AI and machine learning to transform communication data into valuable, actionable insights across multiple channels. This may help a user(s) improve customer satisfaction, operational efficiency, and/or the overall customer experience by analyzing and storing insights based on behavior, preferences, and pain points across every interaction.

The system may benefit from utilizing a centralized data processing architecture. The UC may integrate various communication channels into one ecosystem, enabling user(s) to access data from voice calls, live chat, email, video interactions, and/or social media all in one place. This centralization may enable omni-channel insights because it allows the system, and consequently one or more users, to view and/or analyze customer interactions across multiple touchpoints in real time.

The system may perform customer journey mapping. CI may be used to track customer journeys across different touchpoints and predict their next steps. For instance, by analyzing historical interactions, CI may identify patterns enable the system (e.g., a user may be notified) to anticipate what the customer might want or need next.

The system may perform sentiment analysis. By analyzing the tone and context of both voice and text communications, the system may assess customer sentiment. This may enable the system (e.g., accessible by the user) to understand how customers feel about their service or product in real-time, leading to quicker response times and more personalized support.

The system may generate automated actionable Insights. The system may analyze the vast amount of data generated across all communication channels and automatically generate actionable insights. These insights may include customer satisfaction trends, potential service bottlenecks, and/or areas where there may be an opportunity to improve customer interactions.

The system enables real-time decision-making. With CI processing interactions as they happen, the system is able to present information/notifications to users to make real-time decisions, such as routing calls to the best available agent (e.g., specific type of user) based on historical customer data or customer sentiment.

The system may have customizable AI Modeling (integrations): The system may allow customizable AI models, including integrations from one or more different AI vendors in single workflows, that may be tailored to the specific needs of a deployment (e.g., different businesses using the UC may have different needs). For example, for a given deployment, AI-driven insights may be configured based on specific industry, customer profiles, and/or goals, ensuring the insights are more relevant and actionable for a specific use case.

In one embodiment, the communication intelligence may be based on the data endpoints available within the overall communication platform. There are many type of endpoints that may be available in such a system, such as voice calls and corresponding call detail records (CDRs), which may be a key source of information. They may include real-time or recorded audio streams, call timestamps, caller and callee IDs, queue or agent data, and/or routing details. By leveraging these details, AI may perform speech analytics to derive sentiment and identify topics, while also supporting call routing decisions based on caller history or sentiment. Similarly, chat conversations from web interfaces, in-app messaging, or third-party platforms offer text logs, timestamps, and contextual metadata-enabling text analytics for keyword identification, intent detection, and the generation of suggested responses.

Other data endpoints may include email interactions represent, with data such as sender/recipient addresses, subject lines, body text, timestamps, and/or attachments. By parsing email threads, the system may detect escalation points, recommend responses, or prioritize messages. Video conferencing sessions may also provide valuable input: recorded or live audio and video, participant lists, session durations, and transcripts all enable real-time sentiment analysis, post-call summaries, and/or deeper collaboration analytics. Social media channels, including public posts, comments, mentions, and/or direct messages, enrich brand monitoring activities and/or help detect emerging issues or trends. SMS and text messaging further expand coverage, offering metadata about senders and/or recipients, message bodies, and/or delivery confirmations. For example, this data may be used to track customer outreach, intent detection, and campaign effectiveness.

In contact center settings (e.g., of the communications platform), the system may gather agent performance logs, queue wait times, and/or post-interaction notes. By tapping into these logs, AI may optimize call routing, identify training needs, and spot common failure points. Meanwhile, CRM and/or other customer profile systems provide purchase histories, account data, and/or details of past support interactions, enabling CI to deliver personalized recommendations and/or predictive modeling. Website interactions and/or web form data add yet another endpoint-such as browsing histories, page clicks, and/or form submissions-allowing the system to offer context-aware interactions or proactive outreach. Integrations with workflow and ticketing systems may provide open or closed tickets, status updates, assigned agents, and/or SLA deadlines, which after analysis may improve routing and escalation.

Calendar and scheduling services may also be endpoints that reveal meeting timings, participants, and/or cancellations, which may provide more coordinated follow-ups and/or resource planning. External integrations with third-party AI vendors and/or specialized platforms may provide access to advanced analytics, domain-specific data, and/or the ability to trigger automated actions in external systems. When these endpoints are aggregated, Communications Intelligence may correlate voice call sentiment with chat or social media posts, track a customer's journey across touchpoints, and provide actionable alerts for real-time decisions. Such centralization of interactions, supported by AI and ML models, enables insights that are timelier, and highly contextual, ultimately streamlining (e.g., reducing operational load and/or timing) operational processes and enhancing customer engagement.

In an example of an AI platform, various services and integrations operate together within a cloud-based communications platform to form AI Platform Building Blocks. The platform's services are organized into distinct layers and components, categorized as shared services, unified communications (UC) services, contact center (CC) services, or platform services, each supporting different communication and contact center functions. Digital channels-such as voice, messaging, and social-feed into a voice and digital core and gateway, which connects to global telco networks, SIP adapters, and third-party Bring Your Own Carrier (BYOC) PSTN options. A customer interaction data platform and an integration framework aggregate data and orchestrate third-party connectors and workflows.

Specialized AI components operate alongside the core platform services. These include native automatic speech recognition (ASR) and large language model (LLM) capabilities, as well as external ASR, LLM, and CRM or knowledge base integrations, allowing AI functionality to be sourced both natively and from external vendors. These AI capabilities support various enterprise and customer-facing functions through a Targeted Platform Engagement Services (TPES) layer, encompassing AI self-service, customer relationship management, workforce engagement, and IT operations. The architecture provides deployment flexibility through default or BYOC configurations. Altogether, the unified communications and contact center services-along with multiple AI and data layers-form a comprehensive, integrated platform capable of drawing on both native and external AI models to deliver omnichannel solutions and insights.

The platform may include one or more additional or alternative data endpoints. The CI may gather and analyze various data endpoints across multiple dimensions. From voice and digital core and gateway data, the system collects call metadata and recordings, including inbound and outbound call details, real-time and recorded audio streams, Call Detail Records (CDRs), and call routing logs. Additionally, digital channel logs-such as conversation data from SMS, messaging apps, and social channels routed through the gateway, including timestamps, sender and recipient IDs, and message content-provide valuable insights.

Integration with global telco and Public Switched Telephone Network (PSTN) allows the CI to access network connection details, such as carrier-specific routing records, call-connection quality metrics, and logs from Bring Your Own Carrier (BYOC) interfaces. It also evaluates real-time telephony metrics like jitter, latency, and throughput statistics, which may impact call quality or influence routing decisions.

The customer interaction data platform may contribute data from cross-channel interaction history by unifying logs from calls, chats, emails, and/or social interactions tied to specific customer or agent identifiers. This is complemented by customer profiles and interaction context, providing consolidated data points on customer preferences, past issues, and account statuses.

Contact center (CC) and unified communications (UC) service layers may offer additional data points. CC data includes agent performance metrics, queue information, skill-based routing configurations, post-call wrap-up codes, and records from ticketing or case management systems. UC data comprises meeting schedules and logs, presence indicators, transcripts from team messaging, and shared workspace documents.

The integration framework incorporates third-party system records from external Customer Relationship Management (CRM) platforms, knowledge bases, and/or billing systems, including detailed account information, ticket history, and product usage logs. It also captures workflow orchestration events triggered by third-party services, such as automatically opening support tickets or initiating marketing automation processes.

AI services, both native and external, may also provide data endpoints. Native automatic speech recognition (ASR) may capture real-time or post-call transcripts, confidence scores, speaker identification data, and/or partial transcripts for live assistance. A native large language model (LLM) may offer text analytics outputs, including but not limited to summarized call notes, sentiment scores, and/or intent detection results. External AI integrations may enhance these capabilities by providing similar analytics, potentially including specialized and/or brand-specific insights.

Additionally, CRM, knowledge base, and/or external connectors may supply additional endpoints such as customer account records like purchase histories, support ticket details, and/or product usage data. They also offer insights into knowledge base interactions, identifying frequently accessed articles, their resolution rates, and topics leading to escalations. Targeted Platform Engagement Services (TPES) may collect AI self-service logs to track user interactions with bots or self-service portals, assessing the frequency, types of requests resolved, and/or customer engagement metrics such as interaction outcomes, usage patterns, and AI workflow success rates.

By centralizing and analyzing these comprehensive and diverse data points, the CI may deliver real-time) or near real-time) insights. This enables the identification of patterns in customer sentiment, automation of routing and ticket assignments, context-aware support for agents, and predictive analysis of future customer needs and potential challenges.

A Customer Interaction Data Platform (CIDP) is a unified, AI-powered solution designed to deliver a comprehensive, 360-degree view of customer interactions across all channels, including voice, chat, email, and/or social media. What differentiates CIDP is its ability to integrate real-time interaction data seamlessly with customer profiles, enabling smarter and more personalized customer experiences throughout their journey. A core component of CIDP is its Unified Interaction and Profile Data Layer, which combines live communication data such as calls and chats with customer relationship management (CRM) information and purchase histories into a single, dynamic layer. This effectively eliminates data silos between different channels and sources.

The platform's streaming data architecture supports real-time insights, providing valuable information during active interactions. This capability powers advanced features like live sentiment analysis, intent detection, and next-best-action recommendations. Additionally, CIDP ensures cross-channel context persistence, enabling agents and AI systems to retain full interaction context across different channels and sessions, resulting in more informed and efficient interactions.

CIDP incorporates embedded generative AI to automate interaction summarization, extract customer intent, and automatically populate records, significantly reducing agent workload and enhancing accuracy. Further, the platform offers robust customer journey intelligence tools that analyze end-to-end customer journeys by leveraging interaction metadata and customer outcomes to drive continuous improvements. Finally, CIDP features an open and extensible data fabric with open APIs and pre-built connectors to various CRMs, helpdesks, and analytics platforms, allowing easy adaptation within diverse technology ecosystems without vendor lock-in.

The CIDP integrates with routing management components through a detailed workflow. The CIDP centralizes customer interaction data from various sources such as CRM databases, non-CRM data including transcriptions from chats, emails, texts, and QMSA topics. This collected data may be funneled through the CIDP API Facade, a central interface managing the data flows and integrations.

The CIDP may interact closely with an insights data warehouse, which stores contextual insights and metadata. Examples of the insights stored include escalation information, customer health scores, attention requirements, customer sentiments, product support details, sales data, customer success management (CSM), and product/add-on information.

The CIDP platform includes an Insight Collector, a component that interfaces with a Workspace Request Handler and a Front-end Data Feed responsible for aggregating and combining insights. This integration allows real-time AI/ML-driven insights to flow smoothly through the CIDP system.

Connected to the CIDP infrastructure is a partner ecosystem comprising external entities, demonstrating the openness and extensibility of the platform for additional integrations or service enrichments.

A workspace and routing layer provides operational functionality, surfacing user-customized insights such as escalated cases, topics most likely to be escalated, frequent customer concerns, and a customer health score. Routing management components utilize AI/ML to manage and route communications intelligently based on priorities indicated by cases needing attention, escalation, or containing negative sentiment.

The workspace and routing layer surfaces concrete operational metrics, including counts of escalations, cases needing attention, and negative sentiment cases. For example, a representative use case may detail a customer's dropped call event, discussed topics, and other key communication elements.

A CIDP operates as a unified, AI-powered central hub, integrating various data sources and distributing insights to multiple destination services within 8×8 Work. The CIDP serves as a central consolidation and orchestration layer, aggregating incoming data and coordinating interactions across the platform.

Several inbound data sources feed into the CIDP, reflecting the breadth of information the platform aggregates. These sources include AI vendors, third-party elements, post-interaction surveys, community posts, social media data, CRM systems, historical interactions, real-time interactions, recordings and transcriptions, support logs, and data from (e.g., Cognigy). The varied nature of these sources reflects the platform's ability to integrate structured and unstructured data from internal systems as well as external channels, forming a comprehensive, omni-channel perspective of customer interactions.

The CIDP feeds enriched and consolidated data into multiple destinations-specific services and functionalities within the 8×8 ecosystem. These destinations include 8×8 Engage, Agent Workspace, Supervisor Workspace, CRM integrations, Sales & Account Workspace, Analytics tools, Public API interfaces, Routing and Queuing services, Automation capabilities, Customer 360 dashboards, Journey IQ for customer journey analysis, and Orchestration functionalities. This output pathway demonstrates how CIDP translates aggregated insights into actionable intelligence that enhances various customer-facing and internal services, ultimately enabling smarter, more personalized, and contextually aware customer experiences throughout their entire journey.

Overall, the CIDP serves a critical role as an integrative, real-time AI-powered solution that bridges multiple data sources with key operational destinations, reinforcing personalized, consistent, and intelligent customer interactions within a communications platform.

In some cases, there may be specific segments of documentation, contracts, etc., related to a communications platform that may be leveraged for specific training sources. This data processed by the CI may provide data insights, feedback, recommendations, contextual reporting and summarizations, etc. These may be tied in and integrated with the other data sources to enable tailored, contextually relevant data to be generated across any business use case. For example, sales/commercial data, such as customer contracts/agreements, training materials, presentations/slide decks, summarizations, deal notes, revenue, tax public-facing filings, etc. For example, customer support/customer support management, which may include help desk tickets, support website, knowledge-base and articles customer support manager (CSM) documentation, notes, etc., customer call analytics, etc. For example, legal and regulatory, which may include prepared legal documents, documents/templates, product terms and conditions, regulatory/data privacy, data security, IP, procurement and vendor-related intel, etc. For example, marketing, which may include branding and brand guidelines, marketing campaigns, taglines, advertising, website, social media, etc. For example, product & engineering, products, features/functionalities, product roadmap and management, development, integration, open source, feedback, demos & environments, configurations, etc. For example, another data point may be customer profiles.

Additionally/alternatively, there may be data points from third-party integrations and public-facing documentation: As noted herein, data may include integrations from third-party vendors such as partners integrating with a communication platform. Further, there may also be data from public-facing documentation made publicly available (e.g., via the web, web crawling/indexing), and/or integrated AI tools (e.g., ChatGPT, Gemini, Claude, etc.).

In some cases, there may be AI model internal/external training for a CI (e.g., 8×8 hosted or 8×8-specific instance with AI/ML provider) rather than a shared AI learning model. In such cases, data may be used for training, but not shared externally. However, this disclosure is not intended to be limited to this instance.

For purposes of CI, data may be collected, indexed, analyzed, leveraged, augmented, etc., from any of the data endpoints described herein. The CI may create a live, ever-growing, extensible ecosystem that provides unique practical applications (in cloud-based communications) that are made possible by leveraging the unique big data of the 8×8 communications platform. For training purposes, it is further beneficial to create targeted data sets for specific use cases (e.g., user-related, service-related, segment/vertical-related), collecting data points and metadata that may be leveraged to generate data insights, importantly including those that inferred (and/or predictive) which go beyond what may be indicated in a specific communication (i.e., the customer says one thing but means another).

Training AI/ML may be possible the data points (e.g., described herein) through various host applications/services (e.g., pertaining to a software communications platform). For instance, the application of trained AI/ML processing (e.g., one or more trained machine learning models) may be adapted to evaluate data sources integrated into an exemplary software platform (e.g., software communications platform such as 8×8 Work), omni-channel orchestration of data points that include native data sources as well integrated third-party endpoints (e.g., third-party integrations including CRM tools). Contextual data may be derived from any data point individually or in aggregation, including historical signal data or current signal data (e.g., an ongoing communication such as an electronic meeting). For example, historical signal data collected using a software communications platform, including from prior user communications, may be combined with current user-specific signal data, device-specific signal data, etc., prior to, during or after an electronic communication (e.g., chatbot interaction), to generate and surface contextually relevant data insights for a user (e.g., agent assisting a customer and/or in different omni-channel communication experiences across a software communications platform). This unique and comprehensive analysis of big data managed through a software communications platform enables the provision of rich and contextually relevant data insights tailored for a specific purpose (e.g., enhance user communication and abilities of agents in communications with customers) and further contextual data that may be leveraged to improve back-end data processing and real-time (near real-time) operation of applications/services including GUI features/functionalities presented to users of application/services, software communications platforms, etc. Exemplary signal data analysis may further be utilized to yield determinations as to how (and/or when) to generate updated analytics (in real-time or near real-time) and/or reporting, as well as when and how often to present data insights and/or suggestions. For example, it is important to properly evaluate a state of communication and identify contextually relevant data within an ongoing communication (e.g., dependent on user's sentiment, topic of conversation, content being presented, user attendance, etc.) relative to historical data and/or predicted patterns of users, which may help to determine not only the correct data to surface but when that data would be most beneficial to users. In further examples, signal data may be analyzed to determine the next steps or actions to be performed to continue communication and user engagement across a plurality of communication channels of a software communications platform (e.g., omni-channel communication experience). As non-limiting examples, this may include automatically taking action to include other users in a communication, sentiment analysis, summarization, setting reminders, follow-up meetings, etc. communicating contextual data representations to agents, support staff pertaining to customer interactions, feedback, etc. Non-limiting examples of signal data that may be collected and analyzed includes but is not limited to: device-specific signal data collected from operation of one or more user computing devices; user-specific signal data collected from specific tenants/user-accounts with respect to access to any of: devices, login to a distributed software platform, applications, services, etc.; application-specific data collected from usage of applications/services and associated endpoints (including third-party endpoints integrated within a software platform), data collected from disparate software platforms that provide disparate types of access characteristics; data collected from data flow architecture including integrated bots in a software communications platform, or a combination thereof. Analysis of such types of signal data in an aggregate manner may be useful in helping generate contextually relevant determinations, data insights, etc. Analysis of exemplary signal data may comprise identifying correlations and relationships between different types of signal data specific to user usage of one or more software data platforms (e.g., software communications platforms) whether the target users are developers/engineers, end users/customers, where telemetric analysis may be applied to generate determinations with respect to a contextual state of any type of user activity with respect to different host application/services and associated endpoints at any point in time (historic, current, or predictive of future). Analysis of signal data, including user-specific signal data, should occur in compliance with user privacy regulations and policies.

In some examples, one or more components are configured to manage application of one or more AI models to enhance processing described in the present disclosure. Trained AI processing is applicable to aid any type of determinative or predictive processing including specific processing operations described with respect to determinations, classification ranking/scoring and relevance ranking/scoring. An exemplary component for implementation trained AI processing may manage AI modeling including the creation, training, application, and updating of AI, ML modeling. Trained AI processing may be adapted to execute specific determinations described herein including those for analyzing specific data and data sources of a software data platform (e.g., a software communications platform) and/or generating insights for management of data flows, GUI feature functionality, or data augmentation. For instance, an AI model may be specifically trained and adapted for execution of processing operations pertaining to analyzing features and functionality of a software communications platform including those non-limiting examples described herein. Non-limiting examples of AI implementation including but are not limited to: analyzing data (and metadata) associated with one or more software platforms including third-party integrations of features/functionalities; analyzing data of past, current or scheduled communications, among other examples.

In one example, trained AI processing comprises a hybrid AI model (e.g., hybrid machine learning model, neural network model) that is adapted and trained to execute a plurality of processing operations described in the present disclosure. In alternative examples, trained AI processing comprises a collective application of a plurality of trained AI models (e.g., 3 trained AI models) that are separately trained and managed to execute processing described herein. In alternative examples, the present disclosure extends to integrating third-party AI modeling and further adapting and customizing said AI modeling to work with specific data and data sources of an exemplary software platform. For example, a third-party AI model may be adapted to work within a software communications platform including data, data sources, and integrations (e.g., APIs, web hooks, etc.) related to features and functionality provided (or extending capabilities) of a software communications platform. In examples where a plurality of independently trained and managed AI models is implemented, downstream processing efficiency may be improved by an ordered application of trained AI models where processing results from earlier applied AI models may be propagated to subsequently applied AI models. For example, a trained AI model may evaluate accesses, seeds, pinecones, indicators, external influences, weighting and the like, and derive data correlations to improve processing and efficiency. This may be utilized to adjust weighting and/or assessed risk levels based on the evaluations.

Non-limiting examples of supervised learning that may be applied comprise but are not limited to: nearest neighbor processing; naive Bayes classification processing; decision trees; linear regression; support vector machines (SVM) neural networks (e.g., convolutional neural network (CNN) or recurrent neural network (RNN)); and transformers, among other examples. Non-limiting examples of unsupervised learning that may be applied comprise but are not limited to: application of clustering processing including k-means for clustering problems, hierarchical clustering, mixture modeling, etc.; application of association rule learning; application of latent variable modeling; anomaly detection; and neural network processing, among other examples. Non-limiting examples of semi-supervised learning that may be applied comprise but are not limited to: assumption determination processing; generative modeling; low-density separation processing and graph-based method processing, among other examples. Non-limiting examples of reinforcement learning that may be applied comprise but are not limited to: value-based processing; policy-based processing; and model-based processing, among other examples. Furthermore, a component for implementation of trained AI processing may be configured to apply a ranker to generate relevance scoring to assist with any processing determinations with respect to any relevance analysis, such as that described herein. Scoring for relevance (or importance) ranking may be based on individual relevance scoring metrics described herein or an aggregation of said scoring metrics. In some examples where multiple relevance scoring metrics are utilized, a weighting may be applied that prioritizes one relevance scoring metric over another depending on the signal data collected and the specific determination being generated. Results of a relevance analysis may be finalized according to developer specifications. This may comprise a threshold analysis of results, where a threshold relevance score may be comparatively evaluated with one or more relevance scoring metrics generated from application of trained AI/ML processing.

Further, aspects may integrate AI/ML modeling to correlate large volumes of data in a contextually relevant manner. This may be used not only for generation (and adaptation) of scoring for types of data to surface but also generation of decision points (e.g., alerting, access control, next steps, omni-channel engagement) as well as generation of data insights/suggestions, reporting, generation of knowledge base, support content, data processing flow configuration recommendations. In addition to broad applicability, approaches according to the present disclosure may be implemented as a scalable solution (e.g., a solution for a company in several different use cases are built (such as department-specific or user group-specific) to more effectively manage a software platform (e.g. communications software platform).

As an example, one or more ML/AI models may be generated, trained and adapted to analyze context of chatbot interactions, for example, to identify sticking points and issues that may persist in a current configuration and data processing flow in an exemplary data orchestration layer. For instance, one integrated chatbot may be configured to manage topics of travel while another chatbot may be configured to handle sentiment analysis. Through analyzing data points of a conversation between a user and service, it may be detected that a user is frustrated with the first chatbot (topics of travel) in that the chatbot wasn't properly assisted with booking of dinner reservations in a selected travel location. This data point, among others, may be determined and fed back to the developers to consider reviewing and modifying the data processing flow, including potential integration of additional bots into an exemplary data orchestration layer, to resolve potential points of frustration for an end user.

In further examples, the AI/ML modeling (or separate additional modeling combined therewith may be adapted) may further analyze additional endpoints of a software communications platform to provide contextual, and cross-functional insights for management of data processing (e.g., in data orchestration layers) or user/customer management. For instance, AI modeling may be applied to analyze a chatbot query and conversation further in the context of other data points across a software communications platform (e.g., chat, messaging, emails, meetings, recordings, CRM data, etc.) to generate persistent data insights application cross-platform to better manage an overall user experience. Continuing the above example re: dinner reservations, patterns of analysis by the adapted AI/ML modeling may learn that this is the third time that the same user has had an issue with this chat, which may be information passed on to customer agents, success managers, etc. to help improve an overall customer experience. In further examples, insights may be generated from such contextual analysis and/or suggestions for remediation which may be presented through a GUI to an agent or user. Moreover, suggested messages may even be generated and surfaced to end users directly (e.g., we know you have had multiple issues with this chatbot, and it must be frustrating, here is how we can address). This may further utilize and expand omni-channel communication capabilities of a software communications platform to build a customized and personalized user experience. Additionally, it provides an avenue for end users (e.g., customers) to provide feedback directly on specific features/functionalities (including pain points) that may then be directed to the engineers and product managers for re-evaluation of data flow and data processing (e.g., via data orchestration layers).

In additional examples, AI/ML modeling may be built, trained, and adapted to manage insight generation and layers of abstraction including ranking and relevance. For instance, contextual analysis of data interactions relative to the plurality of data endpoints for an exemplary software communications platform may selectively generate insights specific to interested parties such as product/engineering, data insights that are specific to end users, and data insights, that are specific to others including third-party vendors (e.g., who may integrate with a software communications platform). Generated insights may be ranked for relevance and propagated accordingly for one or more interested parties, for example, aligning with organizational specifications. Say that an insight was generated for product/engineering to address a potential pain point with a bot data processing flow that has relevance to a third-party vendor integration (e.g., for that chatbot). It is likely that the product/engineering team may want to sync with that third-party vendor to address. Depending on their organizational desires, AI/ML modeling may be used to generate a corresponding data insight for that third-party vendor, associated with the data insight generated for product/engineering, which may foster efficiency in issue communication and remediation in a processing data flow. In other examples, engineering may wish leverage such data insights to automatically raise a support ticket (internally and/or via a third-party vendor) to address data integration issues, among other possible actions.

As disclosed herein, there may be one or more sets of metadata structures for interactions-based (CIDP) data collection across the communications platform that may be utilized as data points for generating contextual representations within a platform, including data insights, recommendations, inferences, predictions, reporting/timelines, actions, process flow adaptations, etc. The unified data schema may be defined to include one or more of the metadata fields and structures set forth in Tables 1-24, such that interaction data from heterogeneous communication channels is normalized into a consistent, schema-governed representation that supports cross-channel correlation, feature extraction, and downstream machine learning processing.

Table 1 illustrates an example of universal identification fields.

TABLE 1

| Field | Description |
|---|---|
| Transcript_ID | Unique identifier for each transcript |
| Transcript_Type | Customer interaction or internal meeting |
| Parent_ID | For related transcripts (e.g., follow-up |
| | conversations) |
| Decision_Impact_Pair_ID | For tracking causal relationships |

Table 2 illustrates an example of temporal metadata.

TABLE 2

| Attribute | Value |
|---|---|
| Date | YYYY-MM-DD |
| Time Start | HH:MM:SS |
| Time End | HH:MM:SS |
| Duration (Seconds) | Total duration |
| Day of Week | Monday-Sunday |
| Week of Year | 1-52 |
| Time Period | Morning/Afternoon/Evening/Overnight |
| Peak Period Flag | Boolean (true if during peak volume) |
| Season | Winter/Spring/Summer/Fall |
| Special Period Flag | Holiday/Weather Event/System Outage |

Table 3 illustrates an example of channel and routing metadata.

TABLE 3

| Attribute | Description |
|---|---|
| Primary Channel | Voice/Chat/Chatbot/Meeting |
| Previous Channel | For channel-switching interactions |
| Next Channel | For subsequent interactions |
| Queue Type | General/Premium/International/etc. |
| Wait Time (Seconds) | Time before connection |
| Transfer Count | Number of transfers/escalations |
| Hold Count | Number of holds |
| Hold Duration (Seconds) | Total time on hold |
| Abandonment Risk Score | 1-100 |

Table 4-1 illustrates an example of customer metadata (external interactions).

TABLE 4-1

| Attribute | Description |
|---|---|
| Customer Segment | Business/Family/Infrequent/International/Elite |
| Loyalty Tier | None/Basic/Silver/Gold/Platinum |
| Lifetime Value | Numerical value |
| YTD Travel Count | Number of trips year-to-date |
| Recent Disruption Count | Last 30 days |
| Device Type | Mobile/Desktop/Tablet/Phone |
| Digital Adoption Score | 1-100 |

Table 4-2 illustrates an example of agent metadata (external interactions).

TABLE 4-2

| Attribute | Description |
|---|---|
| Agent_ID | Unique identifier |
| Agent_Department | Department name |
| Agent_Experience_Level | New/Developing/Proficient/Expert |
| Agent_Personality_Type | Per classification system |
| Agent_Specialty_Areas | List of expertise domains |
| Agent_Training_Completion | Percentage complete |
| Calls_Handled_Today | Count |
| Concurrency_Level | Number of simultaneous interactions |

Table 4-3 illustrates an example of meeting participant metadata (internal interaction).

TABLE 4-3

| Attribute | Description |
|---|---|
| Participant Count | Number of attendees |
| Department Count | Number of departments represented |
| Leadership Level Present | Executive/Director/Manager/Supervisor |
| Decision Authority Present | Boolean |
| Cross Functional Score | 1-100 |
| Technical Expert Present | Boolean |

Table 5 illustrates an example of content and context metadata.

TABLE 5

| Type | Description |
|---|---|
| Primary_Topic | Main subject |
| Secondary_Topics | List of additional subjects |
| Issue_Complexity_Score | 1-100 |
| Technical_Complexity_Score | 1-100 |
| Emotional_Complexity_Score | 1-100 |
| Knowledge_Base_Articles_{—} | List of IDs |
| Referenced | |
| Systems_Accessed | List of systems used |
| External_Factors_Referenced | Weather/Other Airline Issues/etc. |
| Policy_References | List of policies discussed |
| Documentation_Shared | Boolean |

Table 6 illustrates an example of outcome metadata.

TABLE 6

| Category | Details |
|---|---|
| Resolution_Status | Complete/Partial/Unresolved/Escalated |
| Resolution_Path | Standard/Exception/Workaround |
| First_Contact_Resolution | Boolean |
| Next_Steps_Required | Boolean |
| Follow_Up_Scheduled | Boolean |
| Revenue_Impact | Positive/Negative/Neutral |
| Booking_Status_Change | Canceled/Modified/New/Unchanged |
| Compensation_Offered | Type and amount |
| Total_Value_Impact | Monetary value |

Table 7 illustrates an example of sentiment and emotional metadata.

TABLE 7

| Metric | Description |
|---|---|
| Opening_Sentiment_Score | −100 to +100 |
| Closing_Sentiment_Score | −100 to +100 |
| Sentiment_Delta | Change in sentiment |
| Emotional_Trajectory | Improving/Declining/Volatile/Stable |
| Key_Emotional_Markers | List of emotional inflection points with |
| | timestamps |
| Frustration_Indicators_Count | Number of frustration signals |
| Satisfaction_Indicators_Count | Number of satisfaction signals |
| Emotional_Intensity_Score | 1-100 |
| Rapport_Building_Score | 1-100 |
| Empathy_Effectiveness_Score | 1-100 |

Table 8 illustrates an example of pattern metadata.

TABLE 8

| Attribute | Value |
|---|---|
| Emotional Cascade Phase | Initial/Secondary/Protection |
| Time to First Solution | Seconds |
| Time to Acceptance | Seconds |
| Critical Moment Timestamps | List of pivotal moments |
| Response Time Pattern | Quick/Delayed/Variable |
| Conversation Rhythm Score | 1-100 |
| Interruption Count | Number of interruptions |
| Silence Pattern | Minimal/Moderate/Extensive |

Table 9 illustrates an example of language and communication metadata.

TABLE 9

| Metric | Details |
|---|---|
| Key_Phrases_Used | List with counts |
| Question_Count | Total questions asked |
| Clarification_Request_Count | Number of clarifications |
| Technical_Language_Level | Basic/Moderate/Advanced |
| Personalization_Score | 1-100 |
| Communication_Clarity_Score | 1-100 |
| Language_Complexity_Score | 1-100 |
| Word_Count_Total | Count |
| Average_Utterance_Length | Words per turn |
| Jargon_Usage_Score | 1-100 |

Table 10 illustrates an example of quality and compliance metadata.

TABLE 10

| Metric | Description |
|---|---|
| Quality_Score_Overall | 1-100 |
| Compliance_Score | 1-100 |
| Authentication_Completion_Score | 1-100 |
| Required_Disclosure_Completion | 1-100 |
| Script_Adherence_Score | 1-100 |
| Error_Count | Number of errors |
| Correction_Count | Number of corrections |
| Process_Deviation_Count | Number of deviations |
| Policy_Exception_Count | Number of exceptions |
| Security_Protocol_Adherence | 1-100 |

Table 11 illustrates an example of sales and revenue opportunity metadata.

TABLE 11

| Field | Description |
|---|---|
| Upsell_Attempt_Flag | Boolean |
| Upsell_Type | Product/service offered |
| Upsell_Success | Boolean |
| Revenue_Opportunity_Value | Monetary value |
| Revenue_Realization_Rate | Percentage |
| Lost_Revenue_Opportunity_Value | Monetary value |
| Value_Proposition_Effectiveness | 1-100 |
| Objection_Count | Number of customer objections |
| Objection_Resolution_Success | Percentage |
| Future_Opportunity_Indicators | List of potential opportunities |

Table 12 illustrates an example of customer journey metadata.

TABLE 12

| Attribute | Value |
|---|---|
| Journey Stage | Awareness/Consideration/Purchase/ |
| | Service/Loyalty |
| Journey Complexity Score | 1-100 |
| Previous Interaction Count 7 days | Count |
| Previous Interaction Count 30 days | Count |
| Channel Switching Pattern | Description of pattern |
| Digital Attempt Before Contact | Boolean |
| Touchpoint Position | First/Middle/Last in sequence |
| Journey Friction Score | 1-100 |
| Customer Effort Score | 1-100 |
| Experience Continuity Score | 1-100 |

Table 13 illustrates an example of technical and system metadata.

TABLE 13

| Field | Description |
|---|---|
| System_Error_Count | Number of errors |
| System_Response_Time_Avg | Milliseconds |
| System_Limitation_Encounters | Count |
| Workaround_Required_Flag | Boolean |
| API_Calls_Count | Number of system calls |
| Data_Accuracy_Issues | Boolean |
| Integration_Point_Failures | Count |
| System_Performance_Impact | None/Minor/Moderate/Severe |
| Knowledge_Base_Effectiveness | 1-100 |
| Automation_Opportunity_Score | 1-100 |

Table 14-1 illustrates an example channel-specific metadata (voice-specific).

TABLE 14-1

| Field | Description |
|---|---|
| Call_Quality_Score | 1-100 |
| Background_Noise_Level | None/Low/Medium/High |
| Speech_Clarity_Score | 1-100 |
| Talk_Time_Agent_Percentage | Percentage |
| Talk_Time_Customer_Percentage | Percentage |
| Silence_Percentage | Percentage |
| Voice_Tone_Pattern | Description |
| Speech_Rate_WPM | Words per minute |
| Authentication_Method | Voice/Knowledge/Account |
| IVR_Path_Taken | Path description |

Table 14-2 illustrates an example of channel specific metadata (chat specific).

TABLE 14-2

| Field | Description |
|---|---|
| Response_Time_Average_{—} | Average seconds between |
| Seconds | messages |
| Concurrency_Level | Number of concurrent chats |
| URL_Links_Shared_Count | Count |
| Message_Count_Total | Count |
| Message_Count_Agent | Count |
| Message_Count_Customer | Count |
| Typing_Indicator_Duration_Total | Seconds |
| Read_Receipt_Delays | Average seconds |
| UI_Interaction_Count | Number of interface interactions |
| Chat_Transcript_Requested | Boolean |

Table 14-3 illustrates an example of channel-specific metadata (chatbot specific).

TABLE 14-3

| Metric | Description |
|---|---|
| System_Error_Count | Number of errors |
| System_Response_Time_Avg | Milliseconds |
| System_Limitation_Encounters | Count |
| Workaround_Required_Flag | Boolean |
| API_Calls_Count | Number of system calls |
| Data_Accuracy_Issues | Boolean |
| Integration_Point_Failures | Count |
| System_Performance_Impact | None/Minor/Moderate/Severe |
| Knowledge_Base_Effectiveness | 1-100 |
| Automation_Opportunity_Score | 1-100 |

Table 15 illustrates an example of meeting structure metadata (internal meeting-specific metadata).

TABLE 15

| Metric | Description |
|---|---|
| Meeting_Type | Operational/Coordination/Team/ |
| | Leadership/Training/Crisis |
| Meeting_Format | In-person/Virtual/Hybrid |
| Scheduled_Duration_Minutes | Minutes |
| Actual_Duration_Minutes | Minutes |
| Agenda_Item_Count | Count |
| Agenda_Completion_Rate | Percentage |
| Decision_Point_Count | Number of decisions made |
| Action_Item_Count | Number of tasks assigned |
| Participation_Distribution_Score | 1-100 (evenness of participation) |
| Preparation_Evidence_Score | 1-100 |

Table 16 illustrates an example of decision metadata (internal meeting-specific metadata).

TABLE 16

| Field | Description |
|---|---|
| Primary_Decision_Type | Policy/Procedure/Resource/System/ |
| | Strategic |
| Decision_Authority_Level | Informational/Consultative/ |
| | Decisive |
| Decision_Complexity_Score | 1-100 |
| Alternatives_Considered_Count | Count |
| Data_Driven_Decision_Score | 1-100 |
| Implementation_Timeframe | Immediate/Short/Medium/Long |
| Risk_Assessment_Score | 1-100 |
| Expected_Impact_Scope | Department/Division/Organization |
| Customer_Impact_Consideration_{—} | 1-100 |
| Score | |
| Decision_Clarity_Score | 1-100 |

Table 17 illustrates an example of organizational impact metadata (internal meeting-specific metadata).

TABLE 17

| Field | Description |
|---|---|
| Primary_Department_Impacted | Department name |
| Cross_Department_Impact_Score | 1-100 |
| Resource_Requirement_Level | None/Low/Medium/High |
| FTE_Impact_Count | Number of employees |
| | affected |
| Process_Change_Magnitude | Minor/Moderate/Major |
| Training_Requirement_Generated | None/Low/Medium/High |
| System_Change_Required | Boolean |
| Policy_Documentation_Update_Required | Boolean |
| Expected_Implementation_Challenge_Score | 1-100 |
| Organizational_Readiness_Score | 1-100 |

Table 18 illustrates an example of customer experience impact meta-data (internal meeting-specific metadata).

TABLE 18

| Field | Description |
|---|---|
| Expected_Customer_Impact_Type | Positive/Negative/Neutral |
| Customer_Segment_Impact | List of affected segments |
| Expected_CSAT_Impact | Positive/Negative/Neutral |
| Expected_Call_Volume_Impact | Percentage change |
| Expected_Handle_Time_Impact | Percentage change |
| Expected_First_Contact_Resolution_Impact | Percentage change |
| Expected_Digital_Adoption_Impact | Percentage change |
| Expected_Revenue_Impact | Monetary value |
| Customer_Communication_Plan_Score | 1-100 |
| Experience_Continuity_Risk_Score | 1-100 |

Table 19 illustrates an example of structured summary data (transcript summary fields).

TABLE 19

| Field | Description |
|---|---|
| Key_Issue_Summary | 1-2 sentence description |
| Root_Cause_Category | Classification of underlying cause |
| Primary_Customer_Need | Main customer requirement |
| Resolution_Approach_Summary | Brief description of solution path |
| Emotional_Journey_Summary | Brief description of sentiment |
| | progression |
| Key_Decision_Summary | For internal meetings |
| Business_Impact_Summary | Brief description of financial/ |
| | operational impact |
| Key_Success_Factors | List of elements that drove success/ |
| | failure |
| Innovation_Opportunity_{—} | Brief description if applicable |
| Identified | |
| Replicable_Best_Practice_{—} | Description if applicable |
| Identified | |

Table 20 illustrates an example of statistical feature extraction (transcript summary fields).

TABLE 20

| Field | Description |
|---|---|
| Distinctive_Phrase_Vector | NLP-extracted key phrase list |
| Topic_Distribution_Vector | Topic modeling percentages |
| Sentiment_Pattern_Signature | Pattern classification |
| Customer_Need_Vector | Need strength distribution |
| Agent_Approach_Vector | Technique usage distribution |
| System_Interaction_Vector | System usage pattern |
| Resolution_Path_Vector | Solution approach distribution |
| Decision_Type_Vector | For internal meetings |
| Communication_Style_Vector | Style element distribution |
| Exception_Handling_Vector | Exception approach distribution |

Table 21 illustrates an example of cause of relationship metadata (decision-impact pair metadata).

TABLE 21

| Field | Description |
|---|---|
| Source_Decision_ID | ID of internal decision transcript |
| Impact_Interaction_IDs | List of affected customer interaction IDs |
| Time_To_First_Impact | Hours/days until first observed impact |
| Time_To_Peak_Impact | Hours/days until maximum observed |
| | impact |
| Impact_Duration_Days | Total duration of observable impact |
| Causal_Strength_Score | 1-100 |
| Confounding_Factor_Score | 1-100 |
| Expected_vs_Actual_{—} | Percentage alignment |
| Impact_Match | |
| Impact_Distribution_{—} | Even/Front-loaded/Back-loaded/Variable |
| Pattern | |
| Control_Group_{—} | Comparative metric |
| Comparison_Delta | |

Table 22 illustrates an example of implementation quality meta-data (decision-impact pair metadata).

TABLE 22

| Field | Description |
|---|---|
| Implementation_Completeness_Score | 1-100 |
| Communication_Effectiveness_Score | 1-100 |
| Training_Adequacy_Score | 1-100 |
| Tool_Readiness_Score | 1-100 |
| Process_Integration_Score | 1-100 |
| Adoption_Rate_Percentage | Percentage |
| Resistance_Indicator_Score | 1-100 |
| Exception_Handling_Clarity_Score | 1-100 |
| Feedback_Loop_Effectiveness_Score | 1-100 |
| Adaptation_Agility_Score | 1-100 |

Table 23 illustrates an example of cross system reference data (database integration metadata).

TABLE 23

| Field | Description |
|---|---|
| CRM_Record_ID | ID in customer system |
| Booking_Reference_IDs | List of related booking references |
| Loyalty_Transaction_IDs | List of related loyalty transactions |
| Knowledge_Article_IDs | List of referenced knowledge articles |
| Policy_Document_IDs | List of referenced policy documents |
| Related_Transcript_IDs | List of related interactions |
| Quality_Record_ID | Related quality monitoring record |
| Survey_Response_ID | Related customer survey |
| Workflow_Instance_ID | Related workflow process |
| Incident_Record_ID | Related incident or case |

Table 24 illustrate an example of analytics and machine learning meta-data (database integration metadata).

TABLE 24

| Attribute | Description |
|---|---|
| Transcript_Cluster_ID | Unsupervised learning cluster |
| Predictive_Pattern_Match_IDs | List of pattern matches |
| Anomaly_Score | Statistical deviation measure |
| Transcript_Complexity_Vector | Multidimensional complexity score |
| Feature_Importance_Weights | For ML model inputs |
| Model_Confidence_Score | 1-100 |
| Prediction_Target_Values | For supervised learning |
| Similar_Transcript_IDs | List of semantically similar |
| | transcripts |
| Dimension_Reduction_Coordinates | For visualization |
| Training_Dataset_Partition | Train/Test/Validation |

In one embodiment, there may be a customer (e.g., an airline organization), with one or more users, and the customer may run an instance of the communications platform (e.g., for example, a user of the customer may use a front-end representation of the communications platform, such as the 8×8 Work app). A customer profile may be created that includes pertinent information for ingestion and analysis including aspects such as basic metrics (e.g., revenue, employees, fleet, size, hubs, etc.), department breakdowns (e.g., Contact Center that has 300 agents, corporate, maintenance, airline operations, flight operations crew, etc.), as well as other data including provided directly by customer (e.g., preferences, deadlines, etc.) and the vendor of the communications platform (e.g., 8×8) and its employee base that is providing service to the customer (e.g., customer success managers, professional services, engineers, sales managers).

In this embodiment, the CI may evaluate activity relative to usage of the communications platform (e.g., transcription data), for example, by applying and setting (custom) rules (e.g., can be custom to customer, specific type of vertical, global, etc.) to collect data from customer interactions (e.g., could be customer with 8×8 agents, support, etc., or could be customer employee user to employee user, and/or the customer to their customer). In one example, the CI may adaptively apply rules to evaluate transcription data from the airline organization in the form of: Employee data from all departments: transcripts and phone calls; and customer conversations from Contact Center (e.g., transcripts from voice, chat, and/or chatbots).

An employee synthetic data generator agent follows a structured process for generating data that involves one or more data sources, AI models, memory storage, and code execution. The process begins with an input stage linked to a data source containing details for internal transcripts, which is configured with attributes such as a maximum result count (e.g., five), a relevance threshold (e.g., zero percent), a neighboring chunk count (e.g., seven), and a semantic search mode. From this data source, one processing branch loads internal transcript topics into memory, while another provides the data to a first large language model (e.g., Claude). This first model performs an internal transcript generation task and incorporates intellectual property and ethics constraints.

From the first large language model, various processing paths emerge. One path passes output to a code execution block implemented in a general-purpose programming language (e.g., Python), while another path routes output to a second large language model (e.g., ChatGPT), which is responsible for storing internal transcript topics. Additionally, the first large language model loops back to itself to perform a task that writes output to a cloud-based document storage service (e.g., Google Drive), incorporating intellectual property and ethics constraints along with two tool integrations. The second large language model contributes to the process by feeding its output into a memory storage node for internal transcript topics, which includes descriptors such as a communications intelligence pilot designation and a global scope indicator.

The process concludes with an output stage that connects to the code execution block. The system enables interactions and workflow coordination among the various AI models, data sources, and memory storage components in a cohesive process.

A contact center synthetic data generator agent follows a process for generating and analyzing data through AI models. The workflow begins with an input stage leading to a data source containing details for external transcripts, which connects to a first large language model (e.g., Claude). The first large language model may then load previously stored external transcript topics from memory. Processing by the first large language model, functioning as a transcript generator, may lead to multiple downstream connections. One branch passes output to a code execution block implemented in a general-purpose programming language (e.g., Python). Another branch leads to an output stage. A further branch routes output to a second large language model responsible for storing external transcript topics, which then feeds back into the external transcript topics memory for iterative analysis. An additional branch routes output to another large language model instance, which is associated with a cloud-based storage attribute, intellectual property and ethics constraints, and two tool integrations.

From the foregoing, it may be understood that the system supports a workflow involved in integrating external transcript details, analyzing them using AI models, and generating output through code execution.

In some cases, after data is generated through the employee synthetic data generator agent and the contact center synthetic data generator agent described above, trained AI modeling may then be applied to analyze the transcription data, where an AI agent may gather metadata. Trained AI modeling may be built and adapted to be trained based on metadata structures (e.g., described herein) that may be leveraged to analyze collected transcription data for an organization (e.g., an airline organization) so the AI agent may gather key data points.

An AI agent may gather metadata through a structured workflow. In one example, an input stage connects to a data source containing user personal files, configured with attributes such as a maximum result count (e.g., five), a relevance threshold (e.g., zero percent), a whole-document retrieval mode, and a semantic search mode. The next stage involves a large language model configured with intellectual property and ethics constraints, a metadata gathering function, and one or more tool integrations. AI models may have one or more add-ons. From the AI model, there may be additional output.

In some cases, the structure of a workflow, as compared to the employee synthetic data generator agent, the contact center synthetic data generator agent, and the metadata gathering workflow described above, may be expanded to include additional data sources and/or additional AI/ML modeling (e.g., including models specifically trained in various aspects).

In one case, there may be databases to store data (e.g., in memory or via other forms such as a relational database (e.g., SQL) or any other available data storage methodology).

At one point in a process of a communications intelligence system, data may be created or recreated (e.g., based on gathering from endpoints and/or determining metadata) (e.g., and in some cases a communications intelligence data pipeline applied on top of it) based on simulated and/or real transcripts.

A customized and adapted analyzer for the communications platform may be built and applied, where the analyzer may integrate this data and add other correlations. As a non-limiting example, the analyzer may query a database together with a scenario file and a simulated objective key result (OKR) to add business objectives.

A customized and adapted analyzer for the communications platform integrates multiple data sources with an AI model to analyze and produce an output. The data sources include an organizational overview (e.g., an airline company overview), transcript metadata, and objective key results (OKRs). Each data source specifies attributes such as a maximum number of results (e.g., ten for the organizational overview and OKRs, fifty for transcript metadata), a relevance threshold (e.g., ten percent for all sources), a neighboring chunk count (e.g., two for all sources), and a semantic tag to indicate meaningful connections. These data sources feed into a large language model (e.g., Gemini 1.5 Pro), which is configured with AI ethics constraints and a transcript analyzer function. The AI model processes the input from these sources, leveraging their relevance and semantic relationships, to generate an output.

Once the data is analyzed, the customized data intelligence may be output via a user interface (e.g., a dashboard and/or an integration with a unified communications application (e.g., 8×8 Work) that has an adapted front-end graphical user interface) to present communications intelligence components and output for presentation and interaction (e.g., including taking actions, providing feedback, and submitting additional queries or requests). Output may be generated and propagated to a customer (e.g., an airline customer) via the graphical user interface of the communications platform.

In one example, the user interface may be presented through one or more interfaces of the same platform, such as through a mobile interface, a desktop interface, or other form factors. Additionally, preferences may be enabled and, if desired, configured to provide notifications or copies of the output to other user devices or services (e.g., including third-party services) that may integrate with the communications platform. In some instances, the communications intelligence may be presented as a stand-alone application or separate service independent from the communications platform.

In some non-limiting examples, output from the communications intelligence may be generated proactively for users (e.g., a customer such as an airline). For example, the graphical user interface of the system may be adapted to provide a pane or window (e.g., included in a specific graphical user interface representation of a service, such as an agent workspace application (e.g., 8×8 Agent Workspace)) or even its own pop-out graphical user interface window. In any case, presentation of the communications intelligence functionality may be integrated in a manner that lets the user multitask such that it may be presented synchronously with other services, features, and/or functionalities. In other non-limiting examples, the communications intelligence functionality may be presented via a user interface in a manner that enables users to call or utilize the functionality of a communications platform at the user's desire by integrating with an AI bot, where the graphical user interface of the platform is adapted to include presentation of a communications intelligence AI bot.

In some cases, there may be a user interface of a communications platform with a communications intelligence component. Such an interface may include a chat window, where the queries entered into the chat are directed to the AI bot. On one side of an interface, there may be a navigation bar which enables a user to cycle through different functionality of a communications platform. When selected, the AI bot functionality of the communication platform may have more than one interface. Other interfaces within the AI bot may be different chats and or agents that are specific to different AI modeling further, the AI functionality may have one on one, rooms, and or purpose, specific bots, all powered by the CI.

In these cases, there may be several instances of how the communications intelligence feature functionality may be integrated into a communications platform (e.g., 8×8 Work) and how users may interact with a communications intelligence bot. In a first interactive instance, the communications intelligence system and the platform are adapted to enable presentation of the communications intelligence bot as a user of the platform, one with which other users (e.g., users of a customer organization such as an airline) may interact. For example, a user may communicate with the communications intelligence bot using messaging by messaging the communications intelligence bot directly. In an additional instance, a chat group or room (e.g., an “All Company” channel encompassing all users of the customer organization) represents that a user can be engaging across any channel where the communications intelligence bot may not be directly involved, but the user may activate that feature functionality. In one example, the user may simply utilize a call sign such as an at-mention (“@”) directed to the communications intelligence bot (e.g., “@Communications Intelligence” or a platform-specific bot identifier (e.g., “@8×8AI”) to enable queries to be directed to and processed by the communications intelligence bot in whatever channel (e.g., chat, group, call, meeting) that the user is using. In an electronic meeting example, participants may call to the AI bot to activate the functionality within the electronic meeting and/or join the electronic meeting as its own ongoing participant (e.g., a silent participant) to generate contextual insights, actions, and other outputs for meeting participants, all of which may be uniquely leveraged by the communications platform.

Leveraging the power of the communications platform, trained AI modeling that utilizes metadata and transcripts for over two thousand interactions (e.g., over an example time period) to generate a tailored knowledge base for the communications platform may generate a communications intelligence system that benefits a customer organization (e.g., an airline). Continuing with an airline customer as an example, with all of its departments at the beginning and cross-relating them with OKRs, a user may ask questions that span different levels. For example, there may be questions related to interactions (individual, aggregated, or over the entirety of a time period), departments, the entire business, business insights, product strategy, competitive insights, market trends, and public perception and expectations.

In one instance, a contextually detailed query that a customer organization may submit via the integrated communications intelligence AI bot may include analyzing the communications patterns for the organization, asking what the top three opportunities are for increasing revenue through new products or process optimization, and/or summarizing answers for executive-level insights.

In one instance, a contextually detailed query that a customer organization may submit via the integrated communications intelligence AI bot may include analyzing the overall communications infrastructure for the organization and/or asking what the main themes are in the overall communications for a given time period.

In one instance, a contextually detailed query that a customer organization may submit via the integrated communications intelligence AI bot may include asking what the sentiment of the employees is in the internal departments and the contact center, asking the communications intelligence system to provide separated sentiment by department ordered from high to low (e.g., with specifics as to opportunities), and/or requesting the communications intelligence system to order the answer on sentiment from zero to ten and provide a three-to-five word summary on why.

In one instance, a contextually detailed query that a customer organization may submit via the integrated communications intelligence AI bot may include asking the communications intelligence system to highlight disruptions across the organization's services and highlight where those disruptions are impacting the OKRs, and/or listing by disruption and informing on impacted OKRs (e.g., as well as requesting a three-to-five word explanation on why).

In one instance, a contextually detailed query that a customer organization may submit via the integrated communications intelligence AI bot may include asking what patterns in the communications of the organization could be extrapolated to unseen trends to develop products, process changes, and competitive differentiation for the future, and/or requesting the top three opportunities ordered by impact and confidence due to sample size (e.g., as well as summarizing answers in three to five words).

In one illustrative example, a graphical user interface associated with a communications and analytics platform is presented for facilitating interaction between a user and an automated intelligence module. The interface includes a multi-pane layout comprising a navigation pane, a conversation selection pane, and a primary content display region. A navigation pane may provide access to communication functions and system tools. A conversation selection pane may list multiple communication threads, including at least one thread associated with a communications intelligence service.

In the example, a user selects a conversation thread corresponding to the communications intelligence service, thereby causing the primary content display region to render a sequence of messages exchanged within the thread. The displayed messages include previously generated analytical content, such as strategic recommendations relating to operational or financial performance, and newly submitted user queries. For instance, the user inputs a request for recommendations to achieve a specified revenue increase within a defined time horizon.

In response, the system may display an intermediate processing indicator, signaling that the request is being analyzed. Subsequently, the communications intelligence module generates and presents a structured analytical response within the primary content display region. The response may include categorized insights, such as identified opportunities, supporting data observations, and corresponding recommendations. In certain implementations, the response further includes an implementation strategy section outlining actionable steps, prioritized initiatives, and operational focus areas intended to achieve the requested outcome.

The interface may additionally display temporal indicators associated with each message, thereby conveying sequencing and recency of interactions. User input controls, such as a text entry field, are provided to enable continued interaction with the communications intelligence module. In this manner, the system facilitates iterative, context-aware analysis and recommendation generation within an integrated communication environment.

In one illustrative example, a graphical user interface of a communications platform integrated with an automated communications intelligence system is presented. The interface may include a multi-pane arrangement comprising a navigation panel, a conversation listing panel, and a primary conversation display region. The navigation panel may provide selectable icons corresponding to communication and system functions, while the conversation listing panel displays multiple conversation threads, including at least one thread associated with a communications intelligence service operating within a shared or public workspace.

In the example, a user selects a conversation thread labeled as a communications intelligence interaction, thereby causing the primary conversation display region to render a sequence of system-generated messages. The system initially displays a status message indicating that information is being retrieved, thereby signaling backend processing of a request. Subsequently, the communications intelligence system outputs a structured analytical report within the conversation display region. The report includes an evaluation of an individual associated with an operational role, such as a director-level position, and is organized into multiple sections including strengths, areas for potential improvement, and an overall assessment.

The strengths section may enumerate competencies such as proactive communication, technical expertise, problem-solving capability, and leadership, each supported by references to underlying data sources or recorded events. The areas for potential improvement section may identify deficiencies or opportunities for optimization, such as documentation consistency or enhanced trend analysis. The overall assessment synthesizes the identified attributes into a summary evaluation of performance and operational impact.

In certain implementations, the interface further includes a message composition field positioned within the primary conversation display region, enabling the user to submit additional queries to the communications intelligence system. For example, the user may enter a follow-on query relating to fleet composition or other operational data, thereby initiating further analysis. Temporal indicators and system labels may be displayed alongside messages to convey sequencing and system attribution. In this manner, the interface facilitates iterative, conversational interaction with an analytics engine capable of generating detailed, context-aware performance assessments and operational insights.

In one illustrative example, a computer-implemented communications interface is provided in which a user engages with a communications intelligence system to obtain operational insights derived from enterprise data. The interface may present a selectable conversation associated with the communications intelligence system, and upon selection, prior exchanges and newly generated system outputs may be rendered in a conversation context. In the example, a user submits a query requesting information regarding assets associated with an organization, such as a fleet composition.

In response to the query, the communications intelligence system may enter a processing state, during which a status indicator may be presented to signify that analysis is underway. Subsequently, the system may generate and output a structured analytical response that synthesizes information from multiple underlying data sources, including internal transcripts and operational records. The response may include an identification of asset types, models, and variants associated with the organization, along with supporting evidence derived from the underlying data sources.

In certain implementations, the generated output may further include an evidence and analysis section that correlates specific asset types with documented operational activities, routes, or events. The response may additionally include strategic implications, wherein the system may infer impacts of the identified asset composition on operational planning, revenue management, customer experience, and maintenance considerations. Recommendations may also be provided, such as maintaining updated asset inventories, integrating asset data into planning systems, and evaluating asset configurations to support strategic decision-making.

The interface may further support iterative interaction, such that subsequent queries may be entered into a message composition field to refine or expand the analysis. In this manner, the system may facilitate conversational access to synthesized enterprise intelligence, enabling users to obtain context-aware insights and recommendations based on aggregated operational data.

In one illustrative example, a computer-implemented communications interface is configured to support interaction between a user and a communications intelligence system that generates data-driven operational insights and recommended actions. The interface may present a conversation context in which a user submits a query relating to organizational assets, such as the composition and status of a fleet. In response, the communications intelligence system may process the query and generate a structured output derived from aggregated enterprise data sources, including operational records and internal communications.

In the example, the system may determine and present a quantitative summary of assets associated with the organization, including a total count of assets within the fleet. The system may further generate an inference based on the underlying data, indicating that a subset of the assets is not currently operational. For instance, the system may identify that a number of assets are undergoing maintenance or repair and have been out of service for a defined duration. This inferred condition may be presented alongside the quantitative summary to provide contextual insight beyond the original user query.

Additionally, the communications intelligence system may propose one or more actionable operations in response to the identified conditions. Such actions may include initiating a request for status updates from an external service provider responsible for asset repair. The interface may provide a selectable control to accept or trigger the proposed action. In certain implementations, the system may further generate additional suggestions, such as scheduling a communication with a responsible stakeholder, including a proposed time for the interaction. These suggested actions may be presented in association with corresponding selectable controls to facilitate user approval and execution.

Through this arrangement, the system may extend beyond passive information retrieval by incorporating inference generation and action orchestration, thereby enabling users to obtain not only descriptive insights but also guided operational responses within a unified conversational environment.

Data may be interconnected in a communications platform (e.g., 8×8) in a manner that enables uniquely customized responses to user queries. These responses emphasize the applied capabilities of leveraging the unique large-volume data of the communications platform combined with AI training adapted to the metadata structures created for the communications platform. While that processing is happening on the back end of the system, the adapted graphical user interface for the platform emphasizes the practical application of that back-end processing by providing the user with more than just a response to their direct query. For example, the communications platform may analyze and provide a response to a user's direct query (e.g., the total number of planes in a fleet) along with a graphical representation of the data. The communications intelligence may go beyond just a basic query response, and all interactions across the communications platform may be leveraged and utilized to provide data insights including inferences.

For example, an electronic meeting may have been conducted earlier where it was noted that not all planes in an airline fleet are operational. There may have been additional questions raised, but the meeting ran out of time and the questions were left unanswered. Additionally, and contemporaneously, there may have been customer queries about the number of planes that are operational in the airline's fleet that the user may have to address in a follow-up communication with the customer later in the day.

When the user raises the query to the communications intelligence bot to find out the total number of planes in the fleet, the communications intelligence system has the context from across the entire omni-channel communications platform. The user query may be addressed, but it may be inferred, leveraging the added context across the omni-channel platform, that: (i) the query is not exactly what the user intended to find out (i.e., the user stated one thing but meant another); (ii) there may be more useful information and context to provide to the user based on the query relative to the overall context of the customer account (e.g., an airline customer account); and/or (iii) the user may have more follow-up questions and could use more context based on the additional questions posed in the prior meeting that were left unanswered.

An inference data insight is provided for the user, in addition to answering the user's direct query, that highlights capabilities of AI trained and adapted based on the communications platform data. Additionally, understanding the overall communication context of the customer account, the communications intelligence system may provide recommendation actions (and in some examples automatically apply actions on behalf of the user). The suggested actions and recommendations are also inference-based, leveraging the power of the communications platform data and trained AI to provide further practical applications. For instance, the analysis may yield an action to automatically send out status requests to a repair company for planes that are out of service. The user may perform a single click to accept the action, and that may trigger drafting and sending of the status requests (e.g., a one-click, efficient workflow). Additionally, the trained AI, by analyzing all data points and the communication history of the user, may be able to predict that the next communication of the user will be with a fleet manager. Realizing both the user and the fleet manager may not be immediately available, the communications intelligence system may present a proposed time for a call with the ability to create a meeting via a one-click action.

In one illustrative example, a computer-implemented system provides an integrated communications and customer relationship management (CRM) interface configured to unify customer data, interaction data, and derived metadata within a common operational environment. The system may aggregate information from multiple enterprise sources, including CRM records, communication sessions, and analytical services, and may present such information in a coordinated manner to support real-time decision-making during customer engagements.

In the example, a user engaged in a live communication session with a customer may be presented with synchronized data streams corresponding to the interaction. The system may associate the active communication with a customer identity and may retrieve related CRM objects, including account records, opportunities, and historical engagement data. Concurrently, the system may capture and process the interaction content, such as audio or text transcripts, and may generate interaction-level data reflecting the ongoing exchange between participants.

The system may further derive metadata from the interaction data through automated analysis, including natural language processing and sentiment evaluation. Such metadata may include summaries of the interaction, identified topics, detected intents, sentiment trends over time, and key action items. The metadata may be dynamically updated as the interaction progresses and may be linked to the corresponding CRM object and interaction record.

In certain implementations, the interface may support an “agent assist” functionality, whereby the system may analyze the interaction in substantially real time and may generate contextual recommendations or prompts for the user. These recommendations may include suggested responses, policy guidance, or next-best actions tailored to the detected customer intent. The system may also maintain an interaction history log, capturing discrete events and timestamps associated with the communication, thereby enabling retrospective review and auditing.

Additionally, the system may provide visualization components representing the progression of the interaction, such as a timeline or journey indicator reflecting sentiment or event transitions throughout the communication session. The interface may also present structured summaries that consolidate key outcomes, issues, and resolutions derived from the interaction.

Through this arrangement, the system may establish logical associations among customer entities, interaction content, and derived metadata, thereby enabling a unified workflow in which users may simultaneously access customer context, monitor live interactions, receive automated analytical insights, and execute informed actions within a single integrated environment.

In one illustrative example, a computer-implemented analytics and decision-support system is configured to monitor, analyze, and present performance metrics and risk indicators associated with customer interactions and operational workflows. The system may ingest interaction data, such as communication transcripts and event logs, and may derive quantitative and qualitative metrics that are presented to a user through a set of dynamically generated interface components.

In the example, the system may compute and display conversion-related metrics that correlate a number of interaction touchpoints with a desired outcome, such as a completed transaction or sale. The system may determine an average number of interactions required to achieve the outcome and may present a distribution of outcomes across varying interaction counts. Based on analysis of underlying transcripts, the system may further generate recommended actions, such as modifying initial interaction scripts, to reduce the number of required touchpoints and improve conversion efficiency.

In certain implementations, the system may detect and surface operational risks in near real time. For instance, the system may identify elevated abandonment rates within specific communication channels or queues and may project corresponding impacts on customer satisfaction metrics. In response to such detected conditions, the system may generate actionable recommendations, such as temporarily altering workflow steps or reallocating personnel resources, and may provide selectable controls to enable or dismiss such actions.

Additionally, the system may generate composite health indicators associated with accounts, teams, or operational units. These indicators may incorporate multiple signals, including escalation frequency, case aging, sentiment analysis, and historical trends. The system may present temporal visualizations of these signals, enabling users to observe patterns such as spikes in escalations or declines in sentiment over time. The system may also identify and highlight specific risk factors, such as unresolved cases exceeding predefined thresholds or repeated negative customer sentiment, and may provide narrative summaries describing the overall status and contributing factors.

Through this arrangement, the system may continuously evaluate interaction-derived data, generate predictive and diagnostic insights, and present context-specific recommendations and risk assessments. The interface may support user interaction with these outputs, allowing users to take corrective actions, adjust operational parameters, or further investigate underlying data, thereby facilitating proactive management of customer experience and operational performance.

In one embodiment, a communications platform, such as that offered by 8×8, may integrate “Communications Intelligence” through a suite of artificial intelligence (AI) capabilities that continuously learn from the rich data inherent in enterprise communication systems. In this scenario, the platform may ingest and process transcripts, internal chat messages, and system logs in real time, optionally enhancing these data streams with metadata. The AI models that emerge from this process may then be configured to perform tasks ranging from automated alerting to on-demand query responses.

In some cases, organizations may rely on a (e.g., unified) communications platforms to host internal and external voice calls, video conferences, chat exchanges, and/or additional messaging systems. In this context, a significant amount of structured and unstructured data is continuously generated. In this scenario, the communications platform may capture and store conversation transcripts in real time, along with metadata such as participant information, timestamps, and conversation topics. By leveraging such a high volume of continuous data, it becomes feasible to integrate advanced AI models, particularly large language models, which may be trained or fine-tuned on the organization's unique communications corpus.

Communications Intelligence, as discussed herein, refers to the capability of these AI models to extract meaningful insights automatically and continuously from diverse data streams. In this example, the models may help detect anomalies, identify critical tasks, provide recommendations, and respond to queries from users who seek specific or contextual information. Moreover, because the platform has direct access to multiple channels—voice, video, chat, email, and system logs—it is well positioned to deliver timely insights that reflect an evolving organizational context.

In this system, data may be collected from voice and video streams through speech-to-text mechanisms that provide transcribed outputs. These transcripts may then be combined with chat logs, emails, and internal system logs, creating a centralized repository of textual data. At this stage, the workflow may proceed to apply metadata (e.g., as described herein)—such as timestamps, conversation tags, user role, or priority levels—to enrich each dataset. In this scenario, the communications platform may additionally utilize an indexing mechanism to facilitate fast data retrieval, thereby enabling real-time or near-real-time querying by downstream AI components.

The system may also incorporate optional governance and security measures to ensure compliance with relevant regulations (e.g., GDPR, HIPAA) and organizational data retention policies. Encrypted storage and role-based access controls may be included to provide granular control over who can view specific transcripts or logs. Consequently, the AI models that rely on this data may train securely and maintain a high level of trust among end-users and administrators.

Once the data is ingested and properly labeled or tagged, the AI models may be activated to perform various tasks, such as classification, named entity recognition, sentiment analysis, and text summarization. In this example, large language models that specialize in domain-specific terminology may be updated continuously (or periodically) to reflect the latest organizational communications data. Through incremental learning, these models may be fine-tuned on new transcripts, thereby capturing changing industry jargon, new product names, or emerging issues relevant to the business.

In this scenario, multiple smaller, domain-focused models may also be integrated to manage specialized tasks, such as detecting urgent support requests or identifying critical operational updates. The platform may store these models in a scalable model repository, using version control and automated testing pipelines to confirm that each new model iteration meets accuracy and performance criteria before it is deployed for live inference.

To demonstrate how the overall system may function in practice, consider a scenario in which an airline relies on a communications platform for internal meetings and operational messages. The airline aims to keep its fleet at 100% operational status, but there have been indications that a particular repair parts supplier is experiencing delays.

In this scenario, employees might hold a video conference-discussing, for instance, the status of repairs for five percent of the fleet. The platform records and transcribes the meeting in real time, appending metadata such as meeting ID, relevant keywords, and date/time. Simultaneously, an engineer might use the same platform's chat feature to mention that the expected parts shipment is delayed, creating additional textual data. The airline's internal maintenance system logs a related message that indicates the specific items on backorder.

Once these data streams are ingested and indexed, the AI pipeline may proceed to run entity recognition to identify mentions of “fleet planes,” “repair parts,” and “supplier delays.” The workflow may then classify the content under “Maintenance and Operations” and assign a high-urgency tag to highlight the risk of a missed deadline. In this example, the Communications Intelligence module may further correlate these data points to determine that the projected timeline for achieving full operational status is compromised by a supply chain issue.

Following this analysis, the system may optionally trigger an automated notification to relevant departments, such as operations or customer service, suggesting the rebooking of passengers who were scheduled to travel on the planes in need of repair. Alternatively, the workflow may proceed to recommend contacting a secondary parts supplier identified by the AI model from prior maintenance logs. This process demonstrates how, through real-time data capture and AI analysis, the platform may facilitate proactive decision-making.

The Communications Intelligence may have a mechanism by which end-users interact with the AI models. In this scenario, a user interface may be constructed in the form of a conversational chat window or dedicated portal. Users could submit natural language queries such as, “Which parts supplier can we use to replace the delayed shipment?” or “What is the status of our current fleet repairs?” The AI bot, leveraging the communications dataset and underlying language models, may respond with a concise summary of past suppliers, along with relevant contact and delivery timeframe information.

In this example, the UI might also feature a dashboard that displays proactive alerts for high-priority issues, aggregated summaries of open maintenance tasks, or automated recommendations for mitigating the risk of further delays. The system may incorporate a feedback loop in which users can upvote or downvote the relevance of AI-generated results, prompting continuous improvement of the training pipeline. Furthermore, advanced search filters may be included, allowing managers or technicians to locate historical transcripts, logs, or messages that match specific criteria such as date range, keywords, or user roles.

In one embodiment, the AI model training of the CI may happen in real-time or near real-time. Real-time or near-real-time training of AI models in a communications intelligence context may require a specialized set of methods and architectural choices to ensure that the model ingests and adapts to new data rapidly. First, a system may need to capture and process streaming data efficiently, often employing message queues or event-streaming platforms, such as Apache Kafka or AWS Kinesis, along with micro-batching techniques. This approach allows for small, frequent updates, rather than waiting on large datasets to accumulate. To accommodate these rapid updates, organizations may use incremental or online learning methods in their machine learning frameworks, enabling partial-fit or mini-batch training that integrates newly arrived data without re-training from scratch.

Scalable and distributed computing infrastructures may be used, as the high volume of incoming data typically requires a system to spread the training workload across multiple machines. Low-latency storage, such as in-memory data stores or efficiently indexed NoSQL databases, supports swift access to recent data. At the same time, robust model versioning and deployment strategies may help mitigate the risk of introducing errors or “model drift.” Often, this includes deploying new models in controlled stages, sometimes via canary releases or A/B testing, so that the system may monitor performance and revert to an older model if necessary.

Real-time training may use continuous monitoring and feedback. Observability tools, such as Prometheus or Grafana, may be used to track metrics like inference latency, error rates, and accuracy, providing real-time visibility into model behavior. Direct user input, such as tagging a response as irrelevant, may also feed back into the training process, allowing the model to refine itself more precisely over time. On a more technical level, model architectures that separate a core of frozen weights from adapters or lightweight modules—such as LoRA or prefix-tuning—may help minimize the computational overhead required to incorporate incremental changes.

Furthermore, training large neural networks in real-time may require hardware acceleration and parallelization, typically via GPUs or TPUs, which may handle matrix operations and parallel mini-batch processing at speed. Resilient data flow management, including failover and replication mechanisms, may help ensure data integrity if components fail, while schema evolution in the pipeline is crucial for adapting to changes in incoming data formats. In one instance, organizations may need to balance the frequency of updates with the computational intensity of each update to maintain model quality without incurring excessive training costs.

In industries where privacy and regulatory compliance are paramount, robust data handling practices—such as encryption in transit and at rest, as well as granular access controls—may need to be utilized. These measures help ensure that data is protected throughout the continuous training process.

In one embodiment, there may be technical/hardware advantages/improvements in utilizing one or more approaches of a CI as described herein. For example, a global enterprise that handles thousands of voice and video conferences per day. By integrating AI inference capabilities directly into its unified communications (UC) infrastructure, the company may dramatically reduce the need to constantly upload, process, and re-download massive amounts of raw data from remote servers. Instead, speech-to-text conversion and basic analytics occur locally or near the network edge, trimming out unnecessary processing cycles for both the local system and central servers. This real-time approach translates into fewer CPU cycles devoted to data handling, allowing those freed resources to power advanced features such as real-time transcription and sentiment analysis. As a result, employees experience faster, more efficient communication services, while the enterprise's IT department benefits from lower bandwidth usage and decreased overall server load.

In one embodiment, there may be technical/hardware advantages/improvements in utilizing one or more approaches of a CI as described herein. For example, a finance firm that may need to handle real-time risk assessments during high-volume market fluctuations. The firm's UC platform may intelligently aggregate chat, voice, and system alerts before sending them to specialized AI hardware—such as GPUs or dedicated accelerators—for inference. Because the data is already pre-filtered and structured, the AI models need not waste cycles parsing irrelevant material. This streamlined process lowers memory overhead and ensures that the accelerators may run at higher throughput with minimal latency. In practice, the trading floor may handle numerous simultaneous interactions, queries, and risk checks without requiring a correspondingly large increase in GPU capacity, as only critical and properly formatted information is passed on for AI-driven analysis.

In one embodiment, there may be technical/hardware advantages/improvements in utilizing one or more approaches of a CI as described herein. For example, at a large healthcare provider's call center, the communications intelligence (CI) system may incorporate caching mechanisms that store commonly needed patient or procedural data in fast-access memory. When staff query the system—perhaps to confirm a patient's prescription history or check appointment details—the platform pulls most of the required contextual information from nearby caches, avoiding the need to query a distant database repeatedly. This setup leads to faster response times and less network congestion. As a direct benefit, the system may achieve higher queries per second (QPS) on the existing hardware configuration, maximizing resource utilization and delivering near-instant answers to frontline staff who need time-critical patient information.

In one embodiment, there may be technical/hardware advantages/improvements in utilizing one or more approaches of a CI as described herein. For example, there may be a large technology company that deploys a CI solution in a highly distributed manner across multiple regions. Low-latency data transformations, such as speech-to-text for customer service calls, may be offloaded to edge servers situated close to each regional office. Meanwhile, the most resource-intensive components—like periodic re-training of conversational models—are scheduled on centralized clusters equipped with robust GPU arrays. By strategically assigning tasks based on resource availability and urgency, the enterprise keeps latency low for day-to-day user interactions and ensures that heavy lifting is delegated to hardware specifically designed for AI training. This adaptive load distribution not only saves costs by optimizing hardware utilization but also enhances reliability, as each segment of the workflow operates on the most appropriate computational resource.

In some embodiments, a computer-implemented architecture is provided for generating context-aware responses within a communications platform that operates across a plurality of heterogeneous communication channels. Interaction data may be received via an event-driven ingestion layer configured to interface with multiple modalities, including but not limited to voice streams, messaging systems, email services, and third-party system integrations (e.g., CRM, ticketing, or collaboration platforms). The ingestion layer may include connectors, adapters, or APIs that convert incoming channel-specific data into a common event format and publish such events into a streaming infrastructure. In certain implementations, the ingestion layer comprises a distributed message queue or event streaming system (e.g., a log-based streaming platform) that decouples upstream data producers from downstream processing components, thereby enabling high-throughput and low-latency ingestion of interaction events while maintaining ordering guarantees and fault tolerance.

The received interaction data may be processed using a streaming data pipeline configured to buffer, partition, and distribute interaction events across one or more processing nodes. The streaming pipeline may further perform transformation operations to convert channel-specific payloads into a normalized interaction dataset conforming to a unified data schema. The unified data schema may define canonical fields for representing interaction attributes, including timestamps, participant identifiers, channel identifiers, message content, metadata, and contextual tags, thereby enabling consistent downstream processing irrespective of source modality. In some embodiments, the pipeline performs schema enforcement, data validation, enrichment (e.g., metadata extraction, language detection), and serialization into structured formats suitable for storage and retrieval.

A customer interaction data platform (CIDP) may aggregate the normalized interaction dataset with additional data sources, including user profile data and historical interaction data, to generate a unified, cross-channel interaction representation. The CIDP may include one or more data stores, such as columnar databases, document stores, or graph-based storage systems, configured to maintain longitudinal interaction histories associated with users, sessions, or entities. Aggregation operations may include joining interaction events with user profiles, correlating events across channels using identifiers or probabilistic matching, and constructing session-level or user-level interaction timelines. In certain embodiments, the CIDP further generates vector embeddings for interaction data derived from different communication channels and maps such embeddings into a shared embedding space, thereby enabling cross-channel similarity analysis, semantic retrieval, and clustering.

In response to a query or triggering event, contextual data may be retrieved from the unified cross-channel interaction representation maintained by the CIDP and, additionally or alternatively, from a low-latency data store or caching layer that stores recently ingested interaction data. The caching layer may comprise in-memory data grids or key-value stores optimized for sub-millisecond access, thereby reducing retrieval latency for recent interactions within a predefined temporal threshold relative to the query. In some embodiments, contextual retrieval further includes traversing an interaction graph that encodes relationships among interaction events, users, and entities, wherein edges represent temporal, causal, or semantic relationships. Such graph-based retrieval may enable identification of related interactions, topic continuity, or entity associations across channels.

Based on the retrieved contextual data, a structured context object may be generated at inference time. The structured context object may include representations of a current interaction state (e.g., most recent user input, session metadata, active channel) and a cross-channel historical interaction state (e.g., prior interactions, resolved and unresolved topics, user preferences, and inferred attributes). The context object may be represented as a hierarchical or schema-defined data structure that organizes contextual signals in a format suitable for consumption by downstream inference components.

A communications intelligence engine may execute a multi-stage inference pipeline operating on the query and at least a portion of the structured context object. In a first stage, intent disambiguation may be performed to determine one or more candidate intents associated with the query. This determination may be based on features extracted from the current interaction data in combination with contextual features derived from the structured context object, and may utilize one or more classification models, ranking models, or probabilistic inference techniques. In a second stage, contextual enrichment may be performed by refining the structured context object based on the determined candidate intents and relevance scoring applied to cross-channel interaction data. Such refinement may include re-weighting, filtering, or augmenting contextual elements (e.g., prioritizing recent or semantically similar interactions). In a third stage, predictive follow-up generation may be executed to generate at least one predicted subsequent interaction or recommended action. In some embodiments, this stage includes identifying unresolved interaction topics across prior communication sessions and generating a predicted follow-up query or action associated with those unresolved topics.

A response may then be generated by providing the structured context object and the determined candidate intents as input to one or more machine learning models, such as sequence models, transformer-based models, or hybrid symbolic-neural systems. The response may be conditioned on both the query and the structured context object, thereby enabling context-aware output generation that reflects cross-channel interaction history and current interaction state. In some implementations, multiple models may be selectively invoked or ensembled, and model selection or contextual retrieval scope may be dynamically adjusted based on latency constraints, quality-of-service requirements, or available computing resources.

The generated response and/or recommended action may be caused to be presented via a graphical user interface associated with the communications platform, such as a chat interface, agent console, or voice response system. Additionally or alternatively, the recommended action may be executed via integration with an external system through one or more application programming interfaces (APIs), including initiating workflows, updating records, or triggering downstream processes. In this manner, the disclosed system provides a concrete, low-latency, and cross-channel mechanism for context-aware response generation that improves computational efficiency, reduces response latency through caching and streaming architectures, and enhances semantic coherence via unified schema normalization and multi-stage inference.

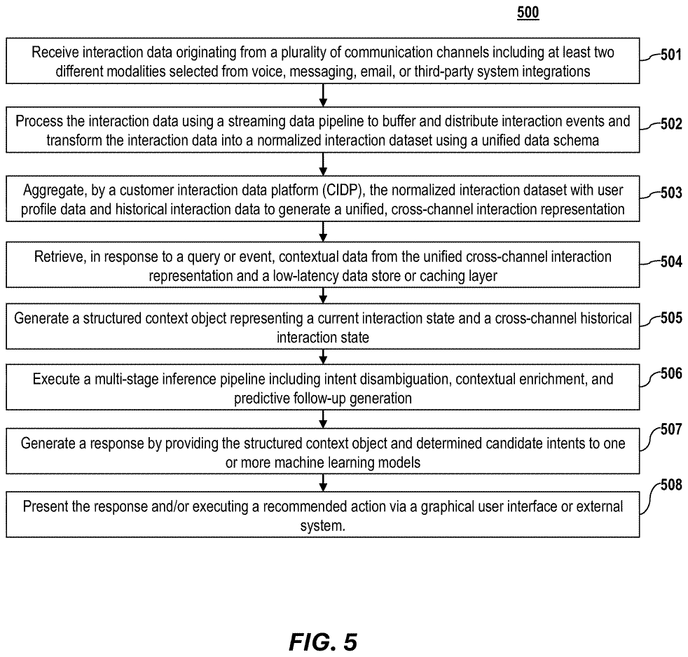

FIG. 5 illustrates an example method 500 for generating context-aware responses in a communications platform. At step 501, interaction data is received from a plurality of communication channels spanning multiple modalities. At step 502, the interaction data is processed via a streaming data pipeline to buffer and distribute events and to transform the data into a normalized interaction dataset using a unified schema. At step 503, the normalized interaction dataset is aggregated by a customer interaction data platform (CIDP) with user profile data and historical interaction data to produce a unified, cross-channel interaction representation. At step 504, contextual data is retrieved, in response to a query or event, from the unified representation and a low-latency data store or caching layer. At step 505, a structured context object is generated representing both a current interaction state and a cross-channel historical interaction state. At step 506, a multi-stage inference pipeline is executed, including intent disambiguation, contextual enrichment, and predictive follow-up generation. At step 507, a response is generated by providing the structured context object and candidate intents to one or more machine learning models. Finally, at step 508, the response and/or a recommended action is presented via a graphical user interface and/or executed through an external system.

As described herein, there may be a process comprising of one or more steps, where one or more steps may have their order changes, be optional, simultaneous, and/or omitted depending on a given use case. It is intended that this process may include one or more elements from the embodiments/examples disclosed herein, even though such inclusion may not be explicit.

Although features and elements are described above in particular combinations (e.g., embodiments, methods, examples, etc.), one of ordinary skill in the art will appreciate that each feature or element may be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “may happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a computer, server, communications platform, UE, terminal, base station, network device, phone device, or the like

As disclosed herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where for example, ‘A/B’ may imply ‘A and/or B’.

As described herein, “etc.” may refer to etcetera, which is intended to reference any other like element in a list, or reference some other element disclosed herein. For example, if a list has “a, b, c, etc.” and another list disclosed herein discloses “a, b, c, d, e” then it is intended that the “etc.” may refer to at least “d, e” or “etc.” may generally refer to other letters in the alphabet.

As described herein, “at least one of” may be interchangeable with “one or more of”.

As described herein, reference of a configuration may mean that at some point a device may receive a message that includes configuration information. In one instance, the device may provide feedback after having received it. In one instance, the device may request the message. In one instance, the message may be unrequested.

What is claimed is:

1. A method performed by a communications platform, the method comprising:
receiving interaction data originating from a plurality of communication channels including at least two different modalities selected from voice, messaging, email, or third-party system integrations;
processing the interaction data using a streaming data pipeline to buffer and distribute interaction events and transform the interaction data into a normalized interaction dataset using a unified data schema;
aggregating, by a customer interaction data platform (CIDP), the normalized interaction dataset with user profile data and historical interaction data to generate a unified cross-channel interaction representation;
retrieving, in response to a query or event, contextual data from the unified cross-channel interaction representation and a low-latency data store or caching layer;
generating a structured context object representing a current interaction state and a cross-channel historical interaction state;
executing a multi-stage inference pipeline including intent disambiguation, contextual enrichment, and predictive follow-up generation;
generating a response by providing the structured context object and determined candidate intents to one or more machine learning models; and
presenting the response and/or executing a recommended action via a graphical user interface or external system.

2. The method of claim 1, wherein receiving interaction data is performed by an event-driven ingestion layer, which comprises a message queue or event streaming system configured for high-throughput, low-latency processing.

3. The method of claim 1, further comprising generating vector embeddings and mapping them into a shared embedding space.

4. The method of claim 1, wherein contextual data is retrieved from an interaction graph encoding relationships among events, users, and entities.

5. The method of claim 1, wherein contextual data includes interaction data ingested within a predefined temporal threshold prior to the query.

6. The method of claim 1, wherein predictive follow-up generation includes identifying unresolved interaction topics and generating predicted follow-up queries.

7. The method of claim 1, wherein the recommended action includes initiating a workflow or updating an external system via an API.

8. The method of claim 1, further comprising dynamically adjusting contextual retrieval or model selection based on latency constraints or computing resources.

9. A communications platform, comprising:
one or more processors;
one or more non-transitory computer-readable media storing instructions that, when executed by the one or more processors, cause the communications platform to:
receive interaction data originating from a plurality of communication channels including at least two different modalities selected from voice, messaging, email, or third-party system integrations;
process the interaction data using a streaming data pipeline configured to buffer and distribute interaction events and to transform the interaction data into a normalized interaction dataset using a unified data schema;
aggregate, via a customer interaction data platform (CIDP), the normalized interaction dataset with user profile data and historical interaction data to generate a unified cross-channel interaction representation;
retrieve, in response to a query or event, contextual data from the unified cross-channel interaction representation and from at least one of a low-latency data store or a caching layer;
generate a structured context object representing a current interaction state and a cross-channel historical interaction state;
execute a multi-stage inference pipeline including intent disambiguation, contextual enrichment, and predictive follow-up generation;
generate a response by providing the structured context object and determined candidate intents to one or more machine learning models; and
present the response and/or execute a recommended action via a graphical user interface or an external system.

10. The communications platform of claim 9, wherein the communications platform further comprises an event-driven ingestion layer including a message queue or event streaming system configured for high-throughput, low-latency processing of the interaction data.

11. The communications platform of claim 9, wherein the instructions further cause the communications platform to generate vector embeddings of the interaction data and map the vector embeddings into a shared embedding space.

12. The communications platform of claim 9, wherein the contextual data is retrieved from an interaction graph encoding relationships among events, users, and entities.

13. The communications platform of claim 9, wherein the contextual data includes interaction data ingested within a predefined temporal threshold prior to the query.

14. The communications platform of claim 9, wherein the predictive follow-up generation includes identifying unresolved interaction topics and generating predicted follow-up queries.

15. The communications platform of claim 9, wherein the recommended action includes initiating a workflow or updating an external system via an application programming interface (API).

16. The communications platform of claim 9, wherein the instructions further cause the communications platform to dynamically adjust contextual retrieval or model selection based on latency constraints or available computing resources.
